(19) United States
(12) Patent Application Publication
(10) Pub. No.: US 2015/0100480 A1
(43) Pub. Date: Apr. 9, 2015

(54) CURRENCY RECYCLER

(71) Applicant: FIFTH THIRD BANK, Cincinnati, OH (US)

(72) Inventors: Randy Colvin, Hebron, OH (US); Robert Norman, Sunbury, OH (US); Jeffrey Siekman, Loveland, OH (US)

(21) Appl. No.: 14/571,852

(22) Filed: Dec. 16, 2014

Related U.S. Application Data
(63) Continuation-in-part of application No. 14/285,072, filed on May 22, 2014.
Application No. 14/285,072 is a continuation of application No. 13/618,601, filed on Sep. 14, 2012, now Pat. No. 8,756,158.
(60) Provisional application No. 61/535,098, filed on Sep. 15, 2011.

(51) Int. Cl. G06Q 20/18

(52) U.S. Cl. CPC G06Q 20/18
USPC 705/39

(57) ABSTRACT

A non-transitory, computer readable storage medium storing a program for processing financial transactions of a retailer at a currency recycler having a housing, a processor located within the housing, and a currency routing assembly disposed within the housing to move currency to at least one stacker, includes the step of processing deposits at the at the currency recycler. The processor further performs the steps of crediting an account of a user for each deposit, processing withdrawals at the currency recycler, and debiting the account of the user for each withdrawal. Still further the processor performs the steps of reconciling all transactions at the currency recycler at an end of day and allowing a user to modify the end of day based on business needs.

### RELATED APPLICATIONS

This application is a continuation-in-part of U.S. application Ser. No. 14/285,072, filed May 22, 2014, and entitled “Currency Recycler”, which is a continuation of U.S. Pat. No. 8,756,158, filed Sep. 14, 2012, and entitled “Currency Recycler”, which claims the benefit of U.S. Provisional Application Ser. No. 61/535,098, filed Sep. 15, 2011, the disclosures of which are hereby incorporated by reference in its entirety.

### FIELD OF THE INVENTION

The present invention relates generally to a currency recycler; and more particularly to a system and method for securely storing and distributing currency.

### BACKGROUND AND SUMMARY OF THE INVENTION

In many retail establishments, currency security is often an important issue. As the threat of currency theft is often high in retail establishments, many such retail establishments utilize a safe or other device to store large amounts of currency. In order to ensure security of the currency, employees of the retail establishment often do not have access to the deposited currency. By placing currency and other valuables into the safe, oftentimes, the deposited currency is removed from circulation until a bank or other financial institution is able to retrieve the currency out of the safe. However, removing the currency from circulation may put short term financial strain on the retail establishment.

Embodiments disclosed herein include a currency recycler, which may include a note portion and/or a coin portion, that is designed to provide retail establishments with faster availability to their daily cash receivables. By leveraging equipment and data processing to deliver deposit data to the financial institution in an expeditious manner, the retail establishment can gain fast access to deposits. In addition, embodiments of the currency recycler provide counting capabilities that automate the handling of the banknotes. Further, by reducing the amount of touches of the banknotes, reductions in loss funds can be realized.

The point of entry is through the currency recycler, which accurately identifies the banknote value and stores the banknote in either a location where it can be retrieved (recycled) or in a location that is used for storage until retrieved by an armored car provider. Embodiments of the currency recycler are connected to a network that allows for communication of the transaction (deposit/withdrawal) to temporary files that keeps track of the net of the deposits/withdrawals. At the end of the processing day, by accumulating the data to match the retailer establishment's point of sale systems, embodiments disclosed herein are able to provide an output that allows for reconciliation to be automated at the corporate back office.

Thus, embodiments disclosed herein connect the currency recycler to a network that allows for communication at all times. This allows retail establishments to have multiple stores working collectively from one pending balance. By allowing the retail establishments to work from one balance, this removes the need for excess availability to be required within each store thus allowing for the retail to gain access to working capital.

According to one embodiment, a non-transitory, computer readable storage medium storing a program for processing financial transactions of a retailer having a currency recycler having a housing, a processor located within the housing, and a currency routing assembly disposed within the housing to move currency to at least one stacker may implement a process comprising the step of processing deposits at the at the currency recycler by accepting currency in an input port of the currency recycler and moving the currency to at least one stacker by way of the currency routing assembly. The process may further include the steps of crediting an account of a user for each deposit, processing withdrawals at the currency recycler by moving currency from at least one stacker by way of the currency routing assembly to an output port of the currency recycler, and debiting the account of the user for each withdrawal. The process may further include the steps of crediting an account of a user for each deposit, processing withdrawals at the currency, reconciling all transactions at the currency recycler at an end of day, and allowing a user to modify the end of day based on business needs.

According to another embodiment, a non-transitory, computer readable storage medium storing a program for processing financial transactions of a retailer having a currency recycler having a housing, a processor located within the housing, and a currency routing assembly disposed within the housing to move currency to at least one currency holding device may implement a process comprising the step accepting a limited-use access code at an electromechanical lock associated with an access point for at least one currency holding portion of the currency recycler. The process may further include the steps of allowing the user to open the access point for the at least one currency holding portion if the access code is authorized and disabling the limited-use access code after a pre-determined period of time or after the user closes the access point. According to yet another embodiment, a non-transitory, computer readable storage medium storing a program for processing financial transactions of a retailer having a currency recycler having a housing, a processor located within the housing, and a currency routing assembly disposed within the housing to move currency to at least one currency holding device may implement a process comprising the step of allowing a first cashier to login to the currency recycler. The process may further include the step of presenting to the first cashier, on a display associated with the currency recycler, a selection of a first cash register that is associated with the first cashier and which the first cashier can withdraw currency for and deposit currency from. Still further, the process may include the step of processing a first deposit or first withdrawal at the currency recycler by routing the currency through the currency recycler by way of the currency routing assembly, wherein the first deposit or first withdrawal is completed by the first cashier and is associated with the first cash register. The process may also include the steps of allowing a second cashier to login to the currency recycler and presenting to the second cashier, on the display, a selection of a second cash register that is associated with the second cashier and which the second cashier can withdraw currency for and deposit currency from. The process may still further include the step of processing a second deposit or second withdrawal at the currency recycler by routing the currency through the currency recycler by way of the currency routing assembly, wherein the second deposit or second withdrawal is completed by the second cashier and is associated with the second cash register. The first cashier may not be associated with the second cash register and the second cashier may not be associated with the first cash register.

Additional features and advantages of the subject system and method will become apparent to those skilled in the art upon consideration of the following detailed materials which form part of this provisional application.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a computing environment for a currency recycler, according to one or more embodiments shown and described herein;

FIG. 2 depicts computing components in a currency recycler, according to one or more embodiments shown and described herein;

FIG. 3 depicts hardware components of a currency recycler, according to one or more embodiments shown and described herein;

FIG. 4 depicts the hardware components of the currency recycler during a deposit, according to one or more embodiments shown and described herein;

FIG. 5 depicts the hardware components of the currency recycler during a withdrawal, according to one or more embodiments shown and described herein;

FIG. 6 depicts the hardware components of the currency recycler during a long auto-verification, according to one or more embodiments shown and described herein;

FIG. 7 depicts the hardware components of the currency recycler during a short auto-verification, according to one or more embodiments shown and described herein;

FIG. 8 depicts the hardware components of the currency recycler during a bypass deposit, according to one or more embodiments shown and described herein;

FIG. 9 depicts the hardware components of the currency recycler during a bypass withdraw, according to one or more embodiments shown and described herein;

FIG. 10 depicts the hardware components of the currency recycler during repeat withdraw, according to one or more embodiments shown and described herein;

FIG. 11 depicts the hardware components of the currency recycler during a count, according to one or more embodiments shown and described herein;

FIG. 12 depicts the hardware components of the currency recycler during a sort notes procedure, according to one or more embodiments shown and described herein;

FIG. 13 depicts the hardware components of the currency recycler, during a cash load from a verification cassette, according to one or more embodiments shown and described herein;

FIG. 14 depicts the hardware components of the currency recycler during a cash load from an upper unit, according to one or more embodiments shown and described herein;

FIG. 15 depicts the hardware components of the currency recycler during a target level maintenance, according to one or more embodiments shown and described herein;

FIG. 16 depicts the hardware components of the currency recycler during a collection cassette pickup, according to one or more embodiments shown and described herein;

FIG. 17 depicts the hardware components of the currency recycler, further illustrating serial number recognition flow, according to one or more embodiments shown and described herein;

FIG. 18 depicts the hardware components of the currency recycler during a deposit jam, according to one or more embodiments shown and described herein;

FIG. 19 depicts a diagram illustrating implementation setup, according to one or more embodiments shown and described herein;

FIG. 20 depicts a diagram illustrating the currency recycler account structure, according to one or more embodiments shown and described herein;

FIG. 21 depicts a diagram illustrating transaction types for the currency recycler, according to one or more embodiments shown and described herein;

FIG. 22 depicts a diagram illustrating a reconciliation process for the currency recycler, according to one or more embodiments shown and described herein;

FIG. 23 depicts a diagram illustrating a fill/empty process for the currency recycler, according to one or more embodiments shown and described herein;

FIG. 24 depicts a diagram illustrating customer transactions with the currency recycler, according to one or more embodiments shown and described herein;

FIG. 25 depicts a flowchart illustrating operation of the currency recycler, according to one or more embodiments shown and described herein;

FIG. 26 depicts a flowchart illustrating operation of depository versus non-depository transactions, according to one or more embodiments shown and described herein;

FIG. 27 depicts a flowchart illustrating depository versus non-depository debit and credit balances, according to one or more embodiments shown and described herein;

FIG. 28 depicts a flowchart illustrating intraday operation of the currency recycler, according to one or more embodiments shown and described herein;

FIG. 29 depicts a flowchart illustrating end of day transactions of the currency recycler, according to one or more embodiments shown and described herein;

FIG. 30 depicts a flowchart illustrating a physical cash audit of the currency recycler, according to one or more embodiments shown and described herein;

FIG. 31 depicts a flowchart illustrating an example exchange transaction of the currency recycler according to one or more embodiments shown and described herein;

FIGS. 32 and 33 depict example receipts illustrating an example of manual processing for coin and/or checks according to one or more embodiments shown and described herein;

FIGS. 34 and 35 depict a coin recycling unit according to one embodiment, wherein the coin recycling unit may be integrated with any of the currency recyclers disclosed herein;

FIG. 36 depicts a computing environment for a coin recycling unit according to one or more embodiments shown and described herein;

FIG. 37 depicts computing components in a coin recycling unit according to one or more embodiments shown and described herein; and

FIG. 38 depicts a further embodiment of a currency recycler.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

In general, embodiments disclosed herein relate to a commercial system/process that recycles currency. As an example, one or more currency recyclers may be located at one or more respective retailer locations. The currency recyclers may each be linked to a financial account that the retailer has with the financial institution. The currency recycler may provide a mechanism for receiving monetary deposits from the retailer at one of the currency recyclers into the account. The currency recycler may also authenticate the deposit transactions and provide a preliminary indication that the deposits have been accepted. At the end of the day, all transactions may be subject to a secondary verification before being finalized. This final verification may include sending the transactions to the financial institution for settlement processing. The settlement of transactions may occur every day of the week rather than only on weekdays as done on existing systems. Verification could be provided to a courier that restocks the currency recycler; and/or providing verification by the currency recycler itself. Regardless, upon deposit of the currency into the currency recycler (and pending final approval), the currency belongs to the financial institution; with the retailer's account being credited.

Similarly, if a retailer wishes to make a withdrawal from their account for use in the retail location, they can use the currency recycler as they would use an automated teller machine (ATM). Once the retailer is authenticated, the currency recycler can preliminarily debit that retailer's account and provide the requested currency. Again, at a predetermined time (such as the end of the day), the currency recycler can provide a final verification for all transactions.

As such, the currency recycler is configured to document an accounting of the deposits and withdrawals. The deposited currency may be stored in a common reservoir with currency that was provided by the financial institution for withdrawals. This allows deposited currency to be “recycled” for withdrawals. By recycling the currency, the currency recycler can operate without needing a courier to insert/remove currency on a regular basis. Instead, because the currency recycler is maintained and monitored by the financial institution, the technician can wait until the currency recycler indicates that the currency level reaches a predetermined low threshold or predetermined high threshold. Upon receiving the indication, the technician can add additional currency and/or remove excess currency from the currency recycler. Additionally, as the deposited currency belongs to the financial institution, FDIC balance minimums may be more easily met by the financial institution, and the retailer reduces their risk involving theft of deposited funds.

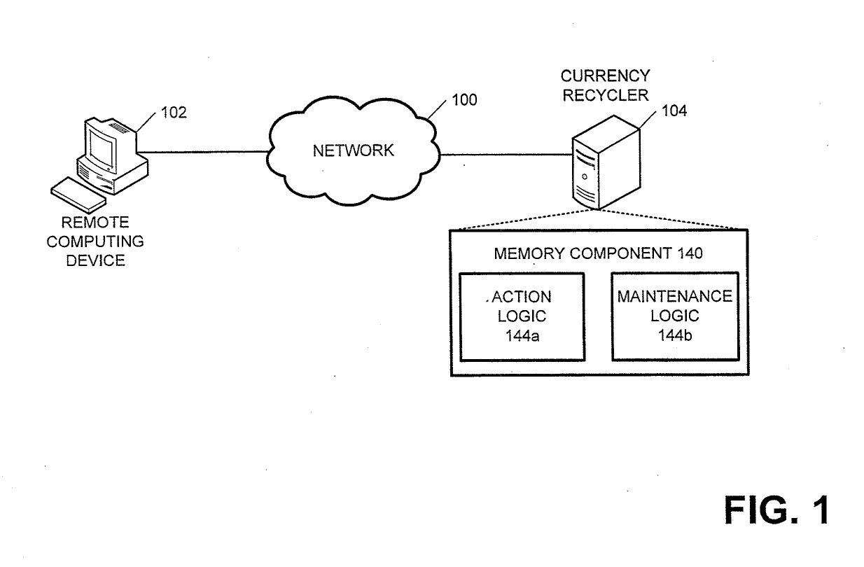

Referring now to the drawings, FIG. 1 depicts a computing environment for a currency recycler, according to one or more embodiments shown and described herein. As illustrated, a network 100 may be coupled to a remote computing device 102 and an a currency recycler 104. The network 100 may include a wide area network and/or a local area network and thus may be wired and/or wireless. The remote computing device 102 may include any portable and/or non-portable computing device, such as personal computer, laptop computer, tablet computer, personal digital assistant (PDA), mobile phone, etc. The remote computing device 102 may additionally include other communication infrastructure, such as infrared, Wi-Fi™, near field communication to function as a remote control of one or more of the devices depicted in FIG. 1.

The currency recycler 104 may be located in a retail environment and may be coupled to the network 100 via a wired and/or wireless connection. The action logic 144a may include software, hardware (such as a programmable logic controller), and/or firmware for providing operational commands to one or more of the service devices 110. Similarly, the maintenance logic 144b may include software, hardware, and/or firmware for facilitating maintenance of the currency recycler 104.

It should be understood that while the remote computing device 102 and the currency recycler 104 are represented in FIG. 1 each as a single component; this is merely an example. In some embodiments, there may be numerous different components that provide the described functionality. However, for illustration purposes, single components are shown in FIG. 1 and described herein.

It should also be understood that while FIG. 1 depicts each of the remote computing device 102 and the currency recycler 104 as being physically coupled to the network 100, this is also merely an example. More specifically, the embodiment of FIG. 1 is depicted to illustrate a communicative connection between devices. This communicative connection may take the form of a wired connection and/or a wireless connection. Thus, depending on the particular embodiment, a physical connection may or may not actually be implemented. On a similar note, the wireless connection may take any of a number of different forms, including a near field communication protocol (such as Bluetooth™, RF4CE, etc.), a mid-range wireless protocol (such as Wi-Fi™, Wi-Di™, etc.), and/or a long range wireless protocol (such as WiMax, 3G, 4G, etc.).

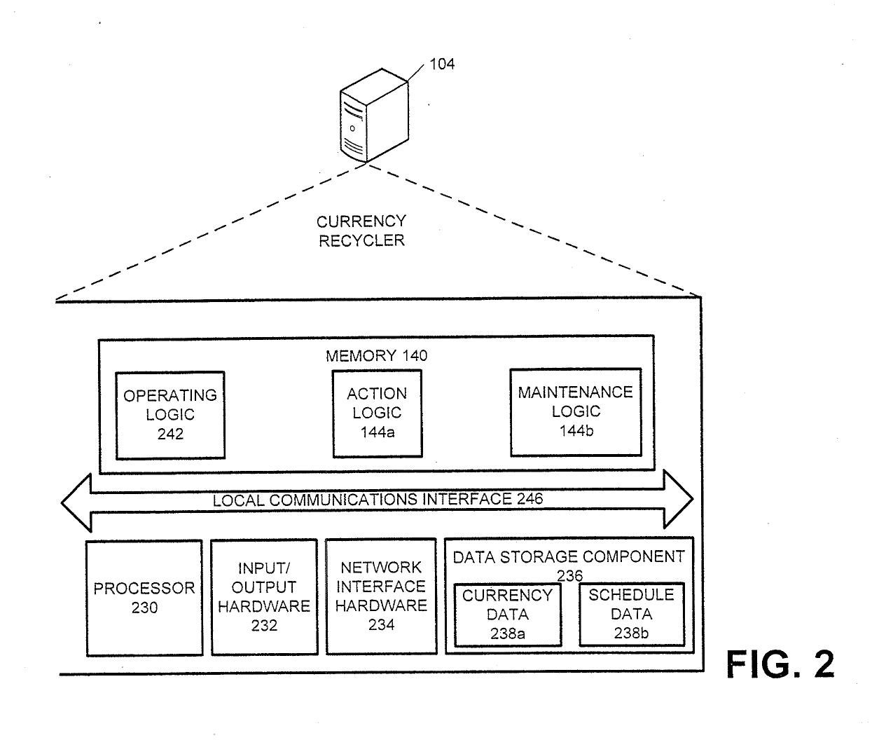

FIG. 2 depicts computing components in the currency recycler 104, according to one or more embodiments shown and described herein. In the illustrated embodiment, the currency recycler 104 includes a processor 230, input/output hardware 232, network interface hardware 234, a data storage component 236 (which stores currency data 238a, schedule data 238b, and/or other data), and the memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, the non-transitory computer-readable medium may reside within the currency recycler 104 and/or external to the currency recycler 104.

Additionally, the memory component 140 may store operating logic 242, the action logic 144a, and the maintenance logic 144b. The action logic 144a and the maintenance logic 144b may each include a plurality of different pieces of logic, each of which may be embodied as a computer program, firmware, and/or hardware, as an example. A local communication interface 246 is also included in FIG. 2 and may be implemented as a bus or other communication interface to facilitate communication among the components of the currency recycler 104.

The processor 230 may include any processing component operable to receive and execute instructions (such as from the data storage component 236 and/or the memory component 140). The input/output hardware 232 may include and/or be configured to interface with a monitor, positioning system, keyboard, display, touch screen, mouse, printer, image capture device, microphone, speaker, gyroscope, compass, and/or other device for receiving, sending, and/or presenting data. The network interface hardware 234 may include and/or be configured for communicating with any wired or wireless networking hardware, including an antenna, a modem, LAN port, wireless fidelity (Wi-Fi) card, Bluetooth™ hardware, WiMax card, mobile communications hardware, and/or other hardware for communicating with other networks and/or devices. From this connection, communication may be facilitated between the currency recycler 104 and other computing devices.

The operating logic 242 may include an operating system and/or other software for managing components of the currency recycler 104. Similarly, as discussed above, the action logic 144a may reside in the memory component 140 and may be configured to cause the processor 230 to control and/or manage one or more of the service devices 110. Similarly, maintenance logic 144b may be configured for facilitating the replacement of one or more parts of the service devices 110. Other functionality is also included and described in more detail, below.

It should be understood that the components illustrated in FIG. 2 are merely exemplary and are not intended to limit the scope of this disclosure. More specifically, while FIG. 2 illustrates a personal computer architecture, other architectures, such as a programmable logic control (PLC) may be utilized for implementing the desired functionality. Additionally, while the components in FIG. 2 are illustrated as residing within the currency recycler 104, this is also merely an example. In some embodiments, one or more of the components may reside external to the currency recycler 104. It should also be understood that while the currency recycler 104 in FIG. 2 is illustrated as a single device, this is also merely an example. In some embodiments, the action logic 144a and/or the maintenance logic 144b may reside on different devices. Further, while the currency recycler 104 is illustrated with the action logic 144a and the maintenance logic 144b as separate logical components, this is also an example. In some embodiments, a single piece of logic may cause the currency recycler 104 to provide the described functionality.

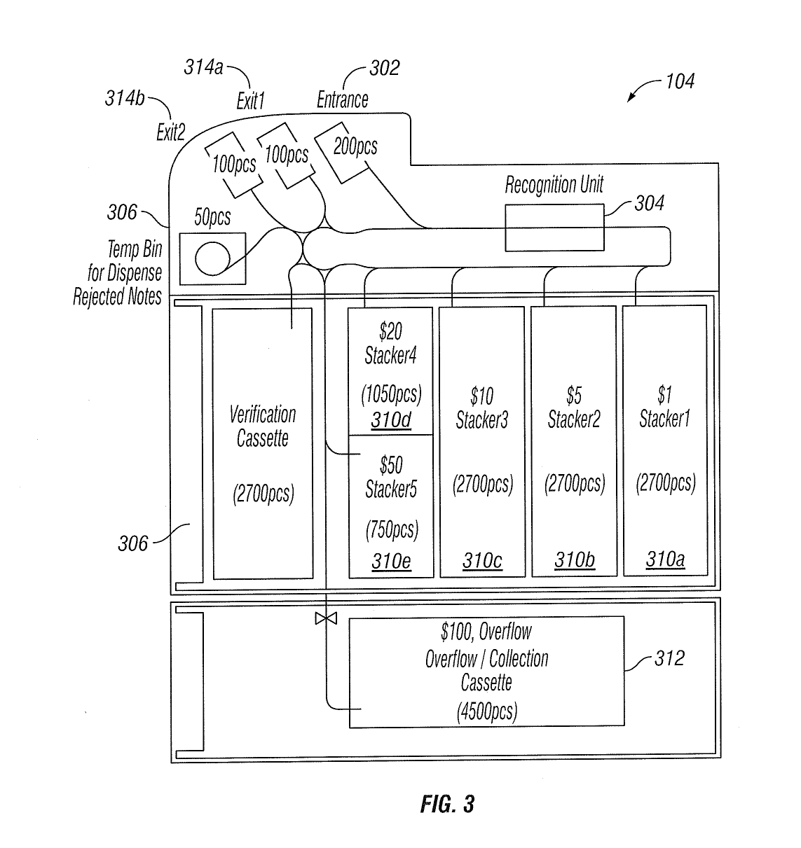

FIG. 3 depicts hardware components of a currency recycler 104, according to one or more embodiments shown and described herein. In the embodiment shown, a currency recycler 104 is depicted and may include an entrance 302, a recognition unit 304, temporary bin for dispensing rejected notes 306, a verification cassette 308, a $1 stacker 310a, a $5 stacker 310b, a $10 stacker 310c, a $20 stacker 310d, a $50 stacker 310e, a $100 stacker/overflow cassette 312, a first exit 314a, and a second exit 314b.

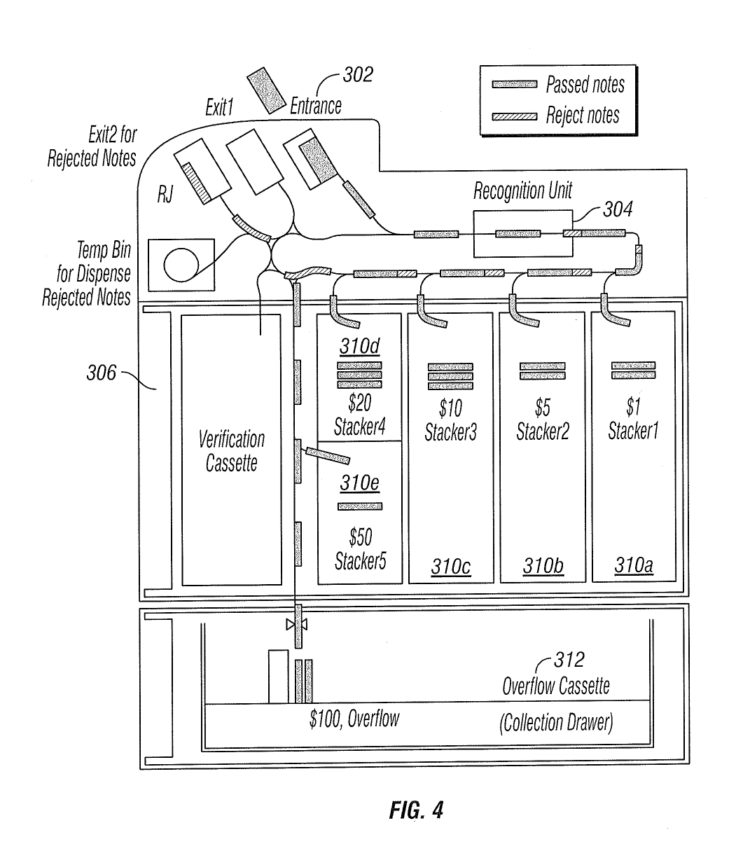

FIG. 4 depicts the hardware components of the currency recycler 104 during a deposit, according to one or more embodiments shown and described herein. More specifically, currency may be placed in the entrance 302 and then sent to the recognition unit 304 for verification that the currency is valid. If the currency is not valid, it may be sent to the temporary bin for dispensing rejected notes 306 and then to the exits 314a, 314b. If the recognition unit 304 verifies the received currency, it may be placed into one of the stackers 310, the overflow cassette 312, and/or the verification cassette 308.

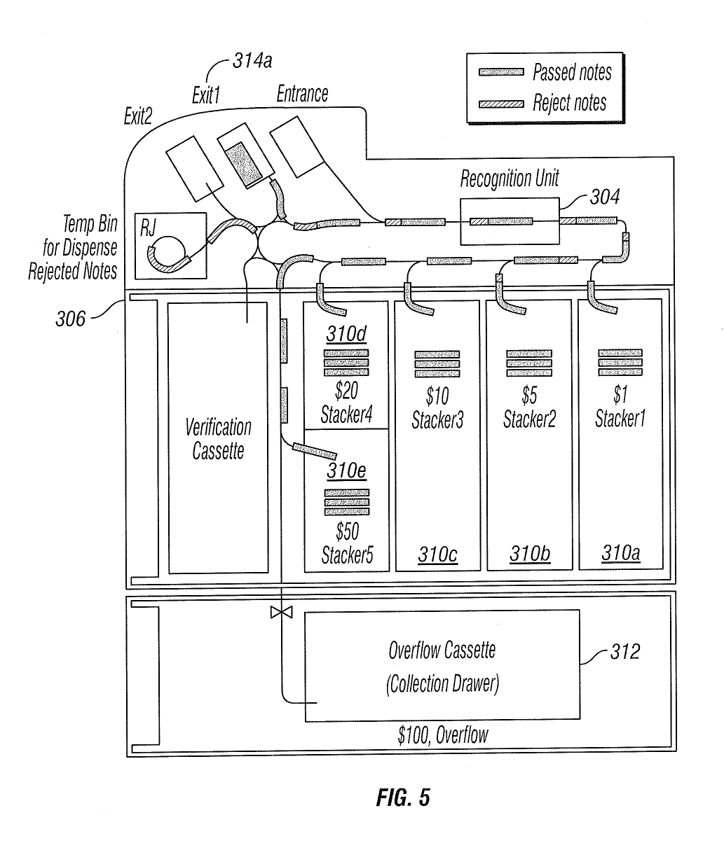

FIG. 5 depicts the hardware components of the currency recycler 104 during a withdrawal, according to one or more embodiments shown and described herein. As illustrated, if withdrawal is desired, the requested amount may be pulled from the stackers 310a, into the recognition unit 304. If the recognition unit 304 passes the currency, the currency may be sent to the first exit 314a. If the recognition unit 304 rejects the currency, the currency may be sent to the temporary bin for dispensing rejected notes 306 for later retrieval.

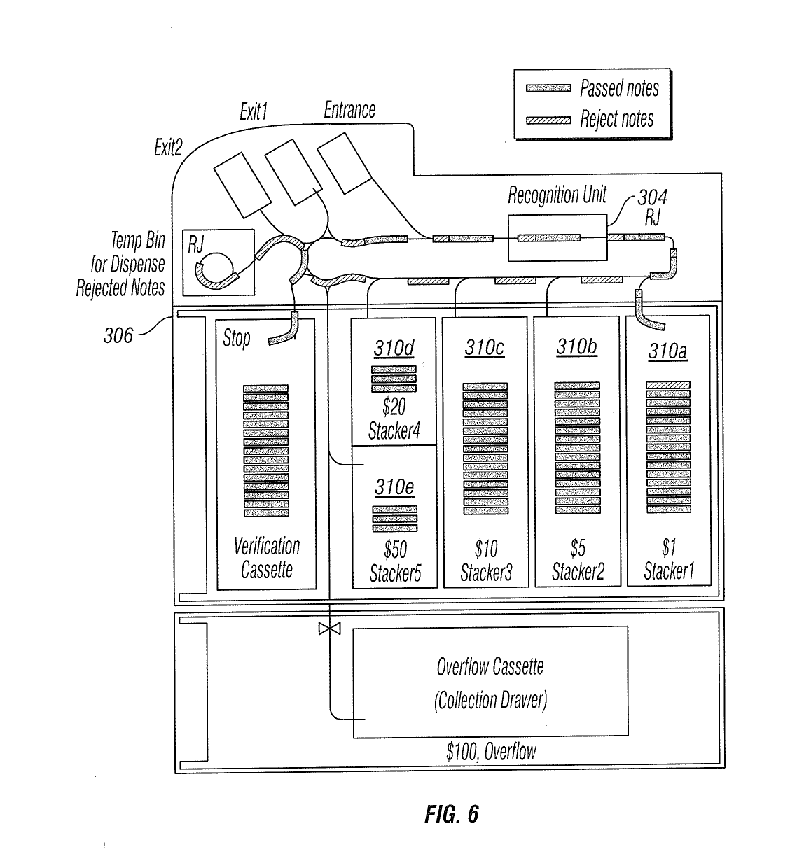

FIG. 6 depicts the hardware components of the currency recycler 104 during a long auto-verification, according to one or more embodiments shown and described herein. As illustrated, currency may be retrieved from a stacker 310a, which may include a rejected note. The currency may then be sent to the recognition unit 304 for verification. The rejected currency is sent to the temporary bin for dispensing rejected notes 306, while the valid notes are sent to the verification cassette 308.

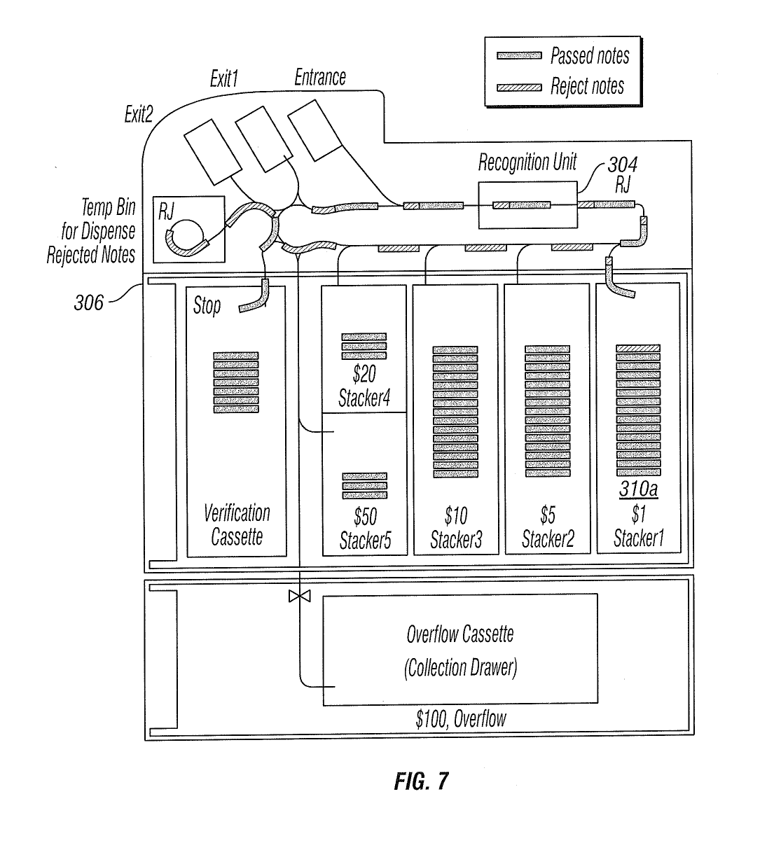

FIG. 7 depicts the hardware components of the currency recycler 104 during a short auto-verification, according to one or more embodiments shown and described herein. Similar to the embodiment of FIG. 6, currency may be retrieved from a stacker 310, which may include a rejected note. The currency may then be sent to the recognition unit 304 for verification. The rejected currency is sent to the temporary bin for dispensing rejected notes 306, while the valid currency is sent to the verification cassette 308.

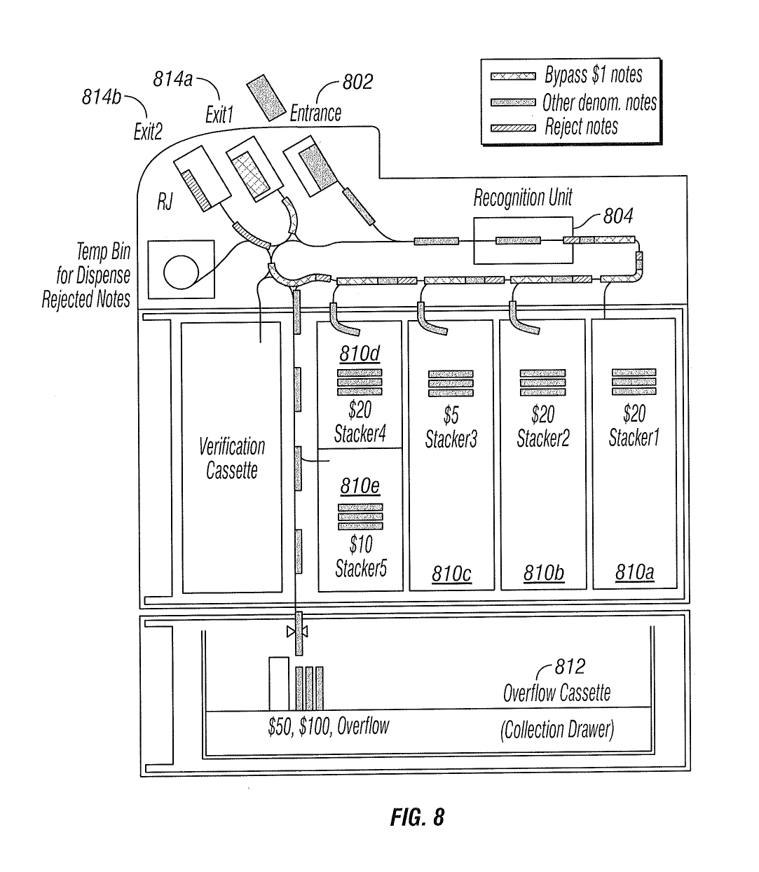

FIG. 8 depicts the hardware components of the currency recycler 104 during a bypass deposit, according to one or more embodiments shown and described herein. In some embodiments, $1 currency may not be available for deposit. As such, currency may be received at the entrance 802 and sent to the recognition unit 804 for verification. The verification may include determining whether the currency is a valid note, an invalid note, and/or a $1 note. If the currency is a valid note, it may be sent to the stackers 810a-810e and/or to the overflow cassette 812. If the currency is an invalid note, it may be sent to the second exit 814b. If however, the currency is a $1 note, it may be sent to the first exit 814a.

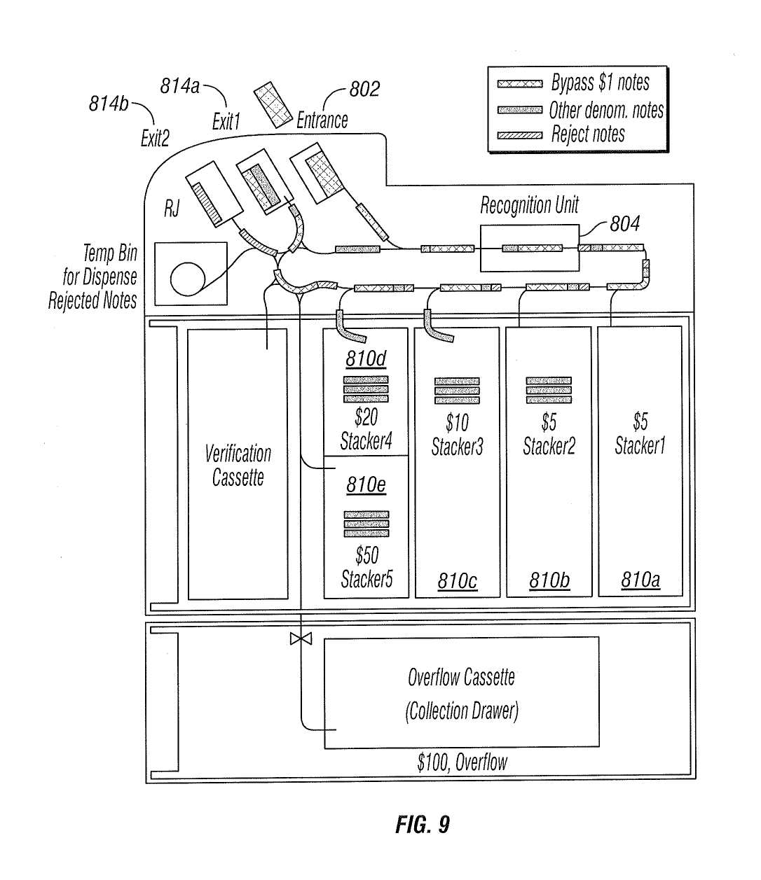

FIG. 9 depicts the hardware components of the currency recycler 104 during a bypass withdraw, according to one or more embodiments shown and described herein. As discussed above, when currency is received at the entrance 802, it may be sent to the recognition unit 804 for verification of validity and/or whether the currency is a $1 note. The rejected notes may be sent to the second exit 814b and the $1 notes may be sent to the first exit 814a. Additionally, upon withdrawal, valid currency may be retrieved from the stackers 810 and sent to the first exit 814a.

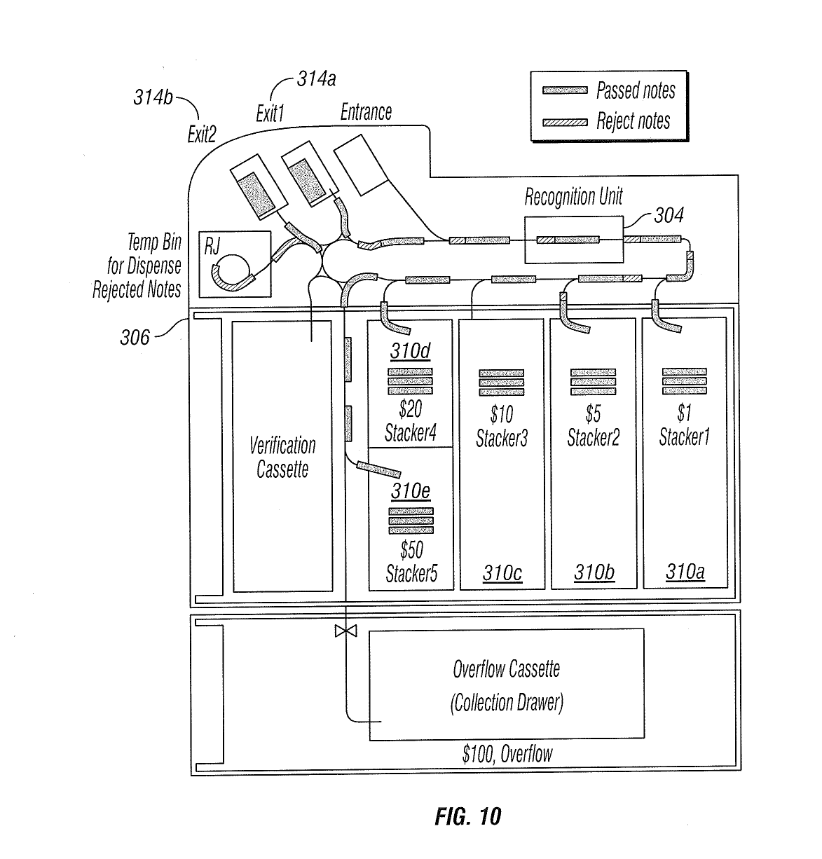

FIG. 10 depicts the hardware components of the currency recycler 104 during repeat withdraw, according to one or more embodiments shown and described herein. As illustrated, if a repeat withdrawal is requested, currency may be retrieved from the stackers 310 and sent through the recognition unit 304. Rejected notes may be sent to the temporary bin for dispensing rejected notes 306, while the passed notes may be sent to the exits 314a, 314b.

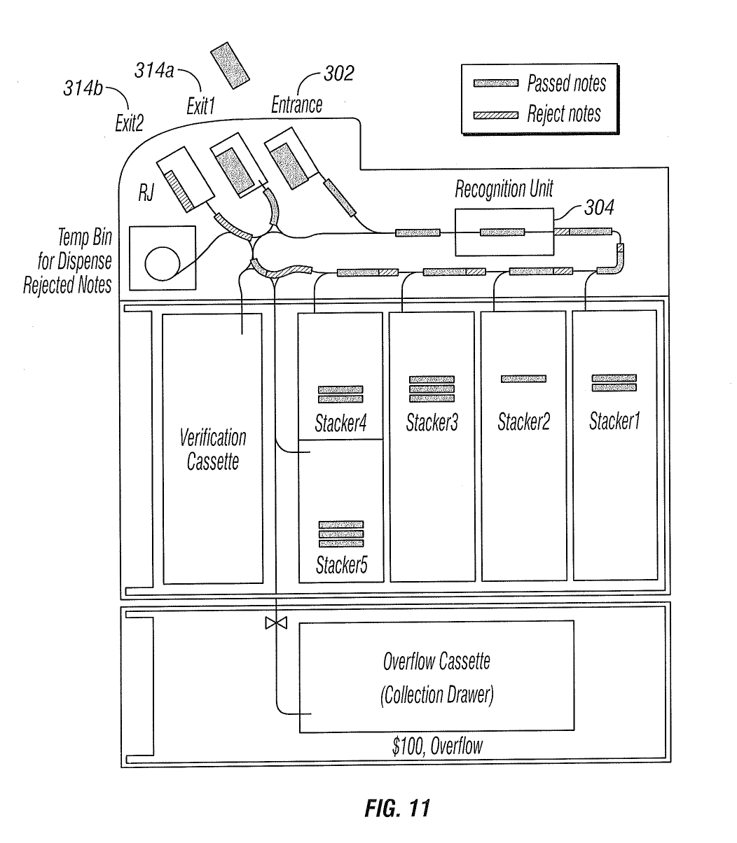

FIG. 11 depicts the hardware components of the currency recycler 104 during a count, according to one or more embodiments shown and described herein. As illustrated, if a user inserts currency into the currency recycler 104 for counting, the currency may be received at the entrance 302. The currency may then be sent to the recognition, which may verify whether the currency is valid. If the currency is valid, the value of that currency may be counted and output to the user. The valid currency may be returned to the user at the first exit 314a. If the recognition unit 304 determines that at least one of the notes is invalid, the invalid currency may be rejected and sent to the second exit 314b.

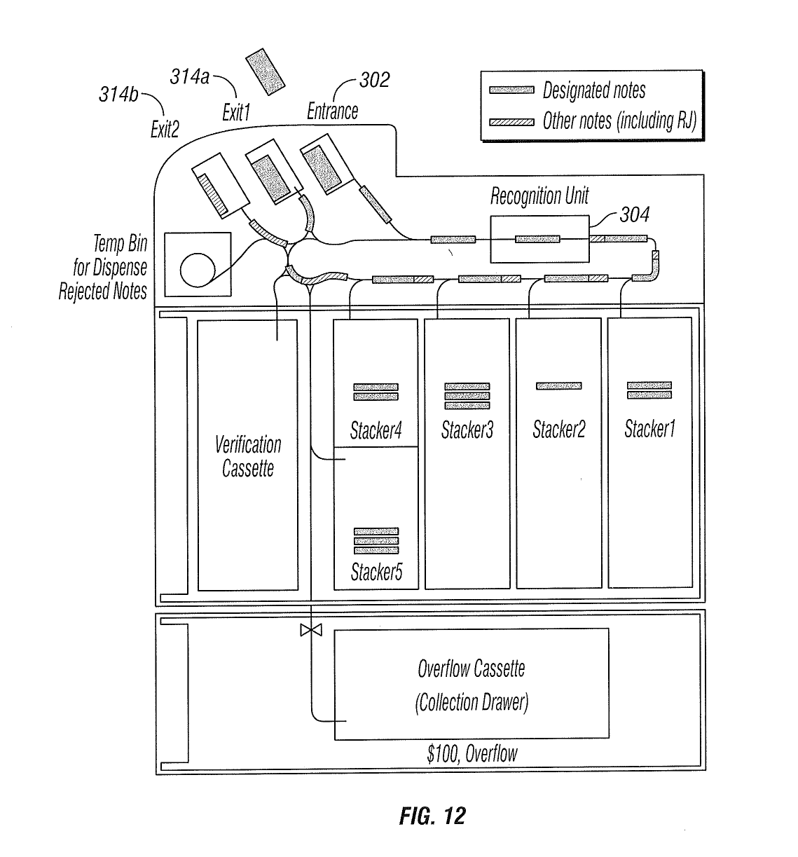

FIG. 12 depicts the hardware components of the currency recycler 104 during a sort notes procedure, according to one or more embodiments shown and described herein. As illustrated, if the user desires currency to be sorted, the user may insert the currency into the entrance 302. The currency may then be sent to the recognition unit 304 for verification and sorting. The invalid notes may be removed from the currency and sent to the second exit 314b. The remaining valid notes may be sorted and returned to the user via the first exit 314a.

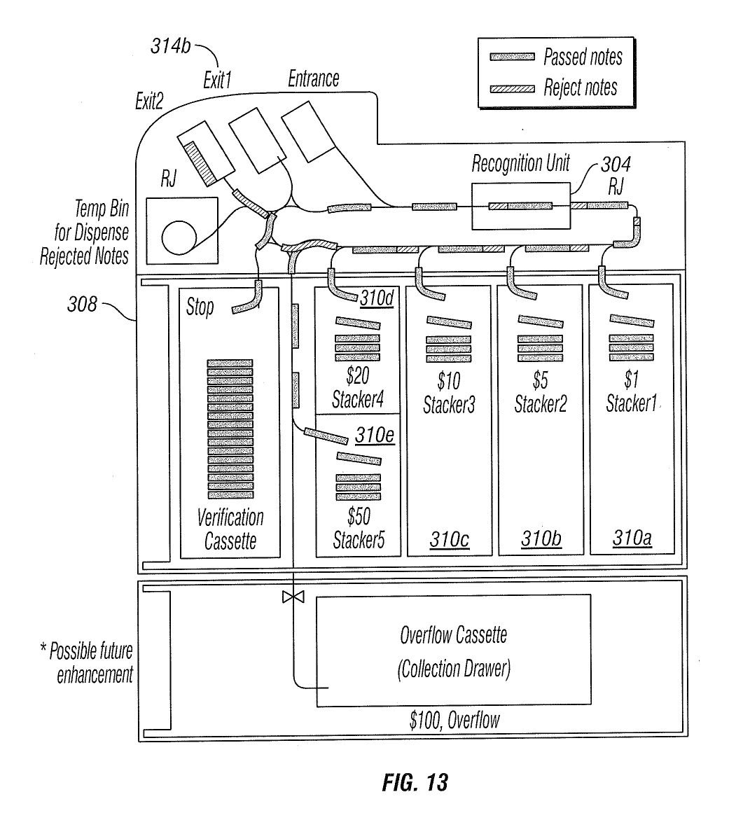

FIG. 13 depicts the hardware components of the currency recycler 104, during a cash load from a verification cassette 308, according to one or more embodiments shown and described herein. As illustrated, currency may be retrieved from the verification cassette 308 and sent to the recognition unit 304. The recognition unit 304 can determine the validity of the notes. The valid notes may be sent to the stackers 310, while the invalid notes may be sent to the second exit 314b.

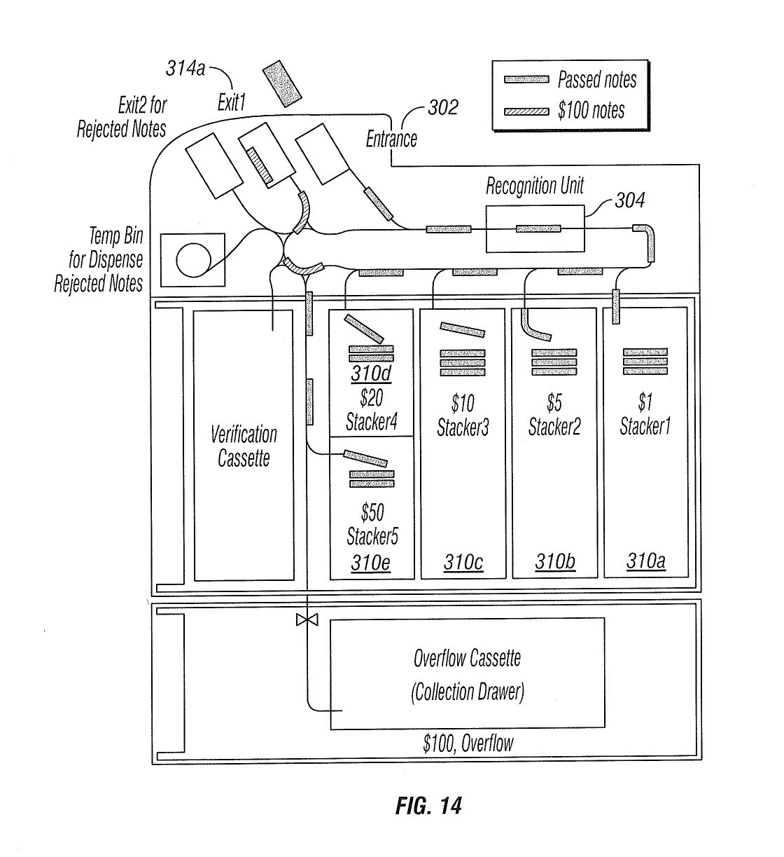

FIG. 14 depicts the hardware components of the currency recycler 104 during a cash load from an upper unit, according to one or more embodiments shown and described herein. As illustrated, currency may be received at the entrance 302 and sent to the recognition unit 304. The recognition unit 304 may determine the validity of the currency and send the valid notes to the stackers 310. The invalid notes may be sent to the first exit 314a.

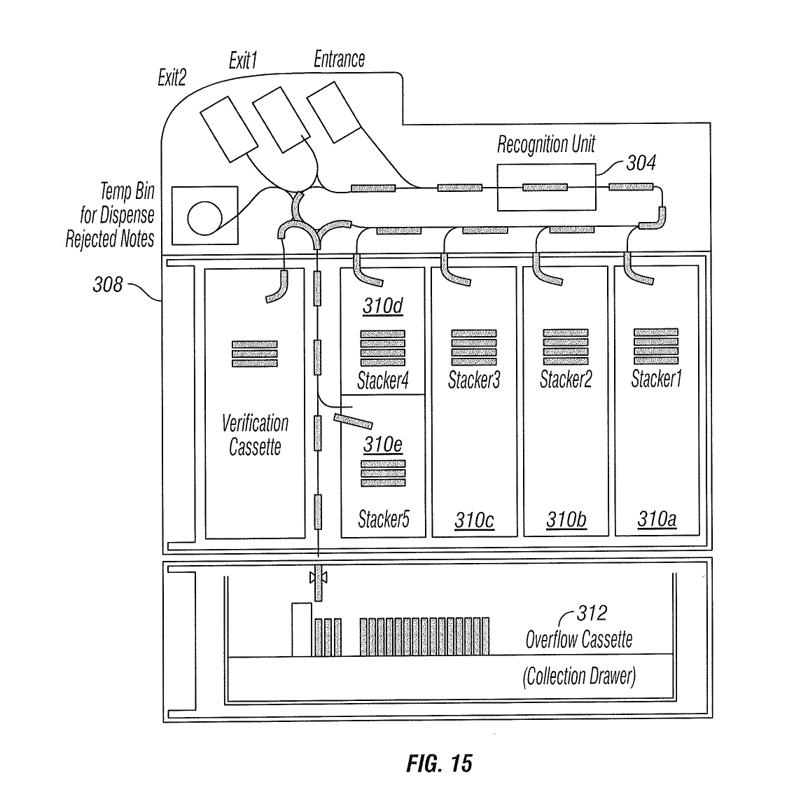

FIG. 15 depicts the hardware components of the currency recycler 104 during a target level maintenance, according to one or more embodiments shown and described herein. In some embodiments, routine maintenance may be performed on the currency recycler 104 to maintain desired levels of currency. As such, currency may reside in the stackers 310, the overflow cassette 312, and/or the verification cassette 308. Currency may be sent from the stackers to the recognition unit 304 for distribution to the verification cassette 308 and/or the overflow cassette 312. Similarly, currency may be sent form the overflow cassette 312 to the stackers 310 and/or the verification cassette 308 and/or from the verification cassette 308 to the stackers 310 and/or overflow cassette 312.

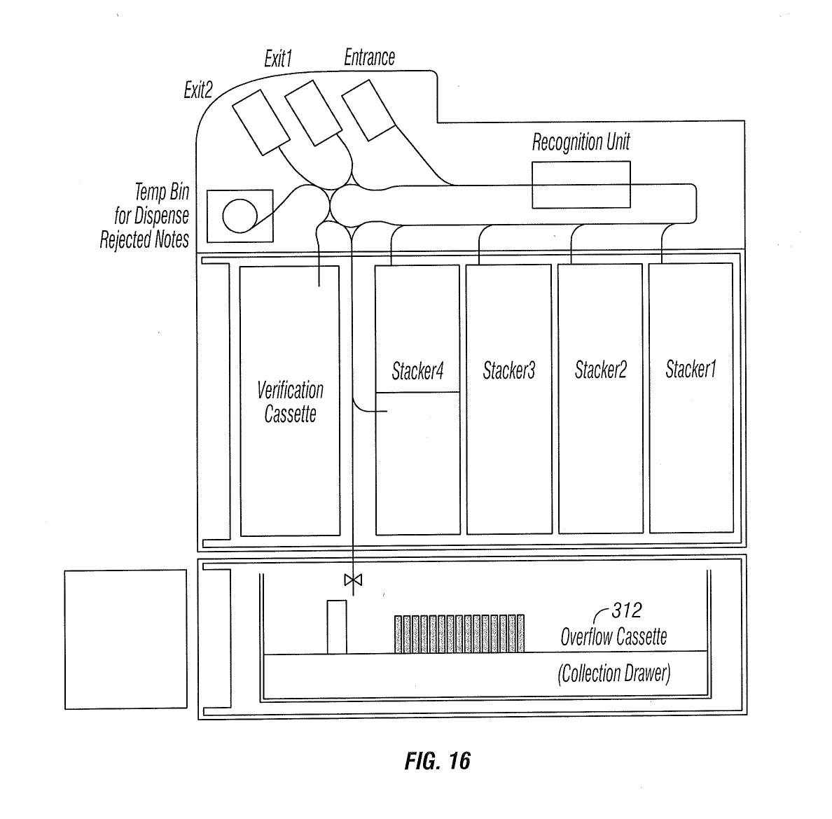

FIG. 16 depicts the hardware components of the currency recycler 104 during a collection cassette pickup, according to one or more embodiments shown and described herein. As illustrated, once the currency is sent to the overflow cassette 312 for pickup, authorized personnel may retrieve the currency from the overflow cassette 312.

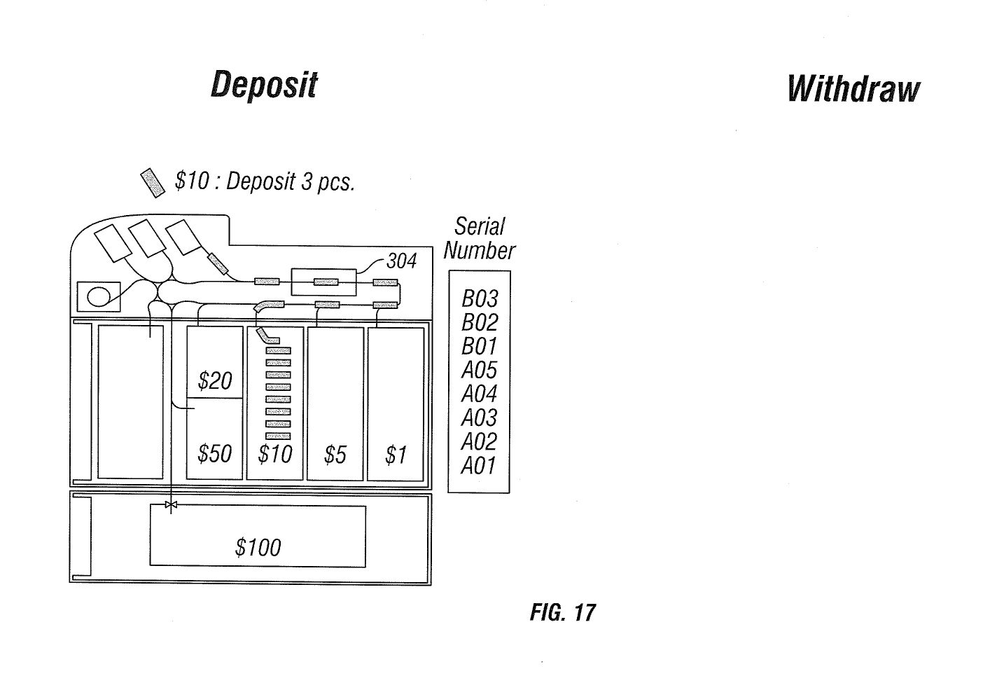

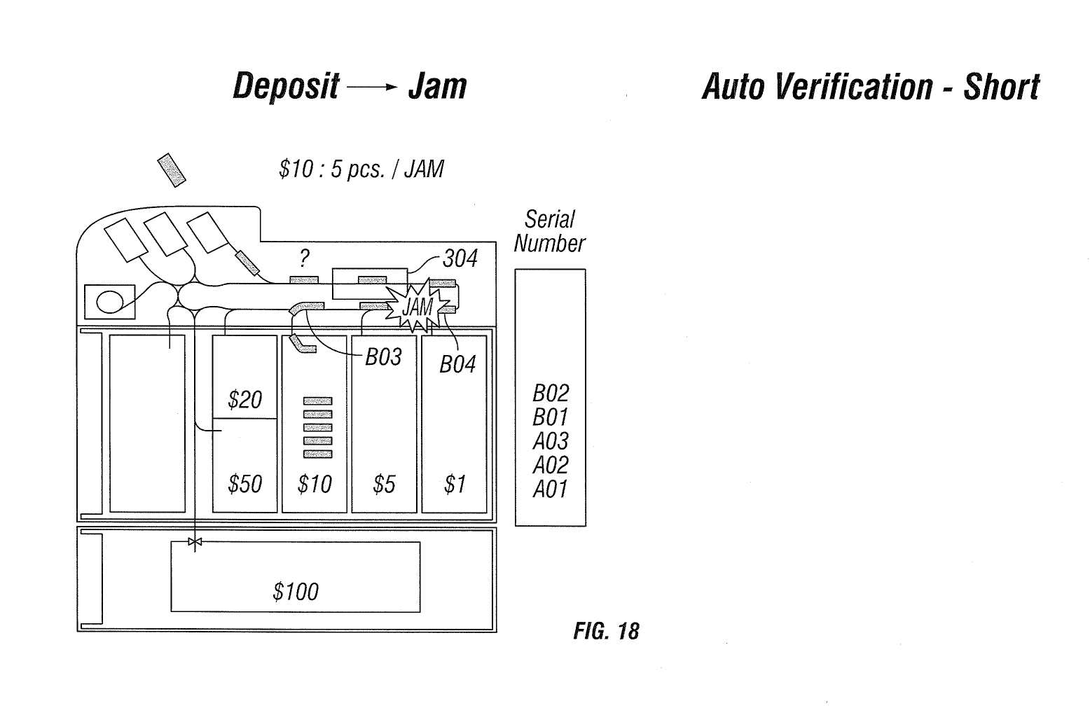

FIG. 17 depicts the hardware components of the currency recycler 104, further illustrating serial number recognition flow, according to one or more embodiments shown and described herein. As illustrated, during a deposit, the recognition unit 304 may determine serial numbers of the notes to determine their validity. The serial numbers may be stored to later use. FIG. 18 depicts the hardware components of the currency recycler 104 during a deposit jam, according to one or more embodiments shown and described herein. As illustrated, when a deposit jam occurs, a determination may be made regarding which note is jammed, based on identifying the notes that have been processed by the recognition unit 304.

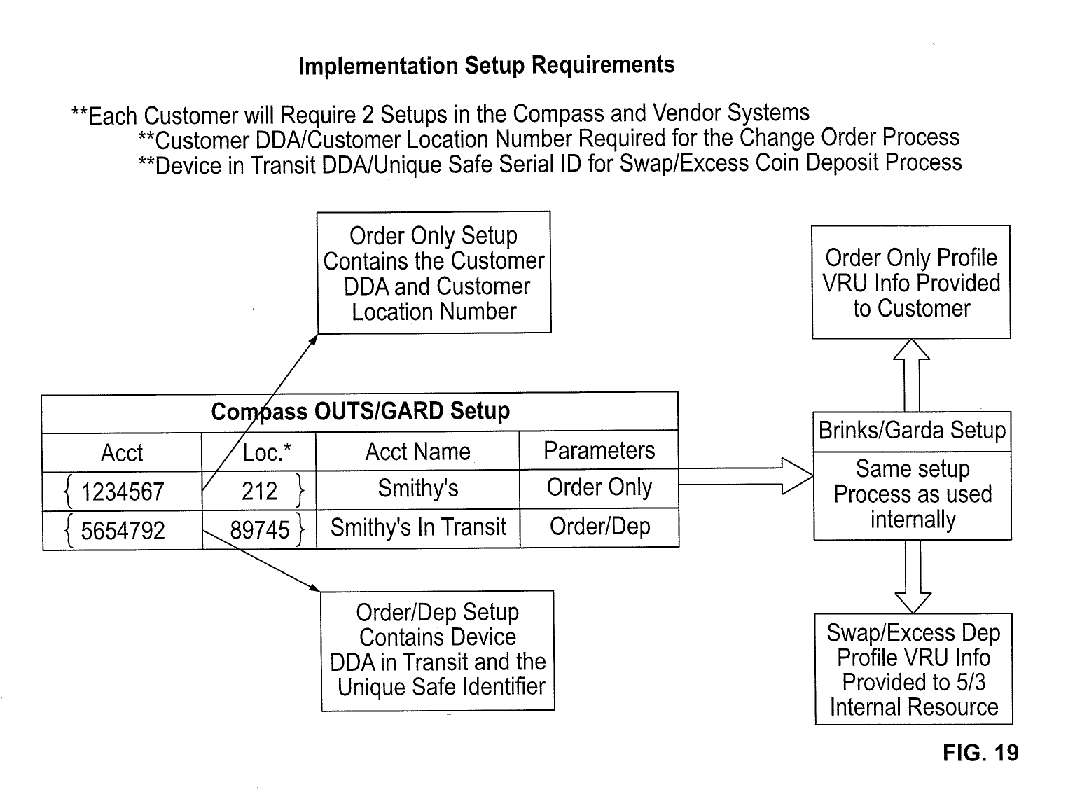

FIG. 19 depicts a diagram illustrating implementation setup, according to one or more embodiments shown and described herein. As illustrated, an account lookup table may be accessed to determine account numbers, location, account name, and/or parameters. Additionally, an order only setup may contain the customer DDA and customer location number. The order Dep setup may contain the device DDA in transit and the unique safe identifier. The Brinks/Garda setup may be a similar process as used internally. The order only profile VRU information may be provided to the customer. The swamp/excess Dep profile VRU information may be provided to the financial institution internal resource.

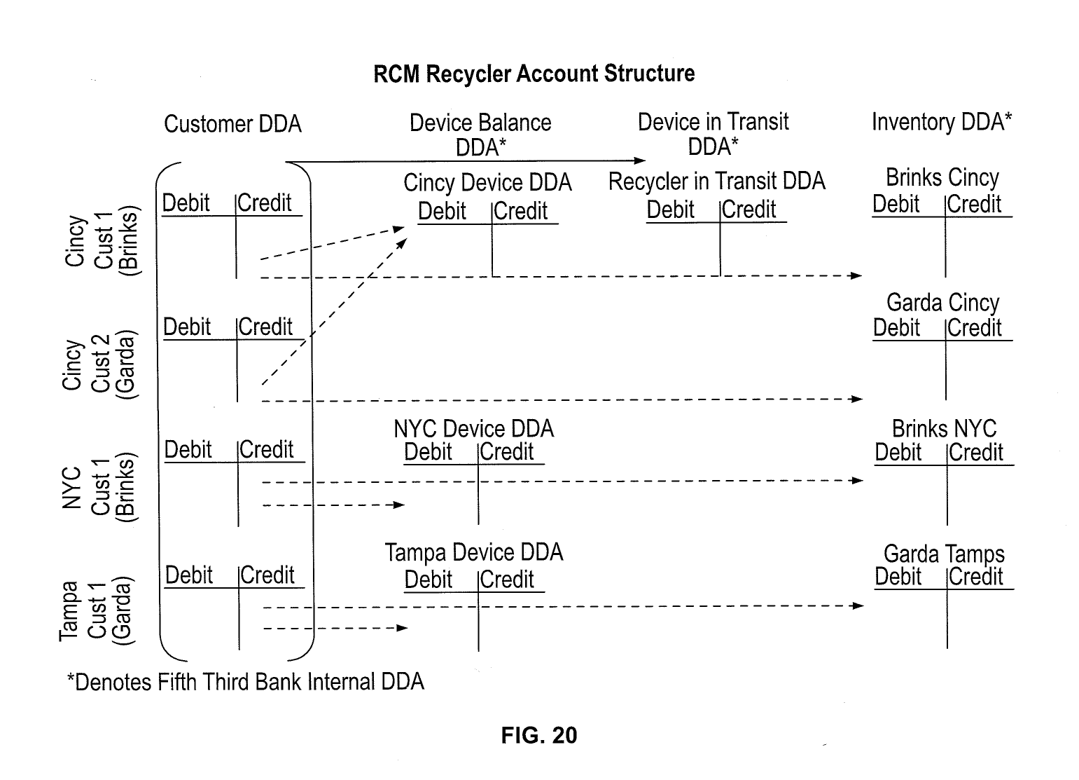

FIG. 20 depicts a diagram illustrating the currency recycler 104 account structure, according to one or more embodiments shown and described herein. As illustrated, the currency recycler 104 account structure may include the customer DDA, which may be unique for each individual retail location and/or may be shared among retail locations, depending on customer preference. Also included is a device balance DDA, which is the financial institution internal DDA. A device in transit DDA is additionally included, which may be built at the product level and may not be vendor-specific. An inventory DDA may also be included for each cash processing market and is vendor specific.

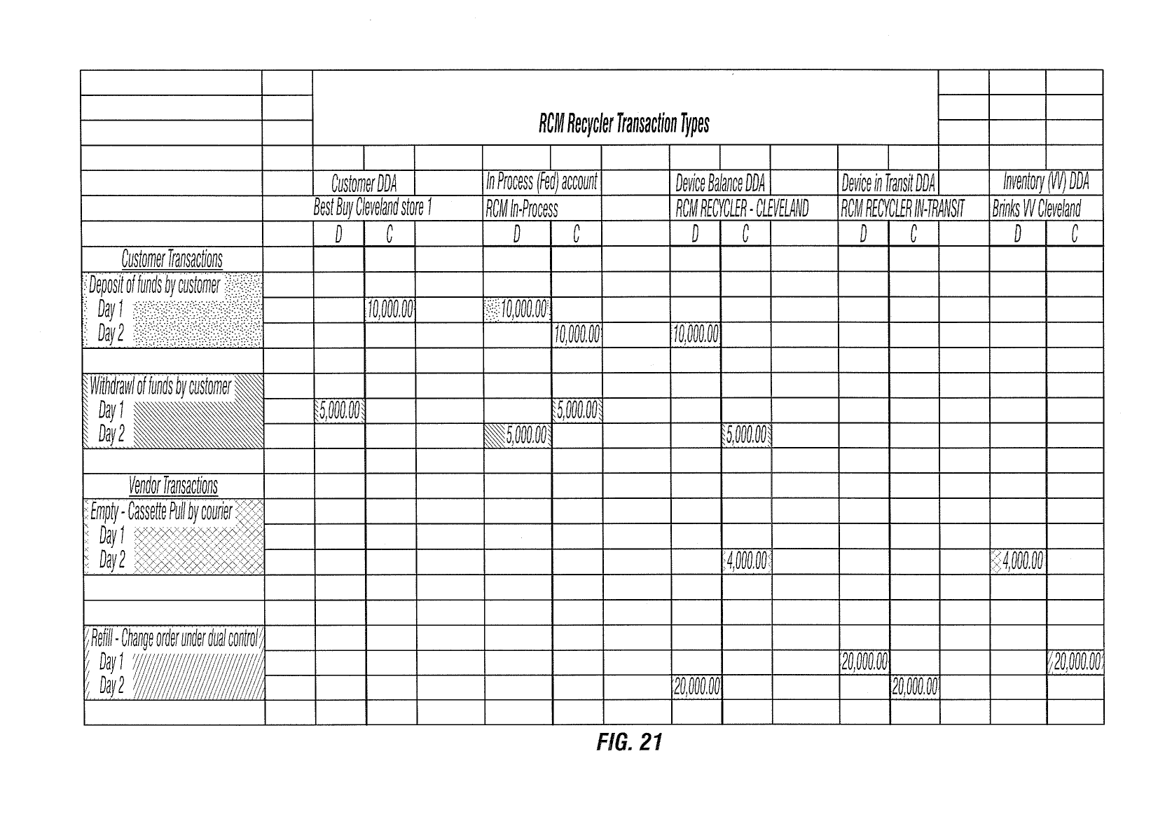

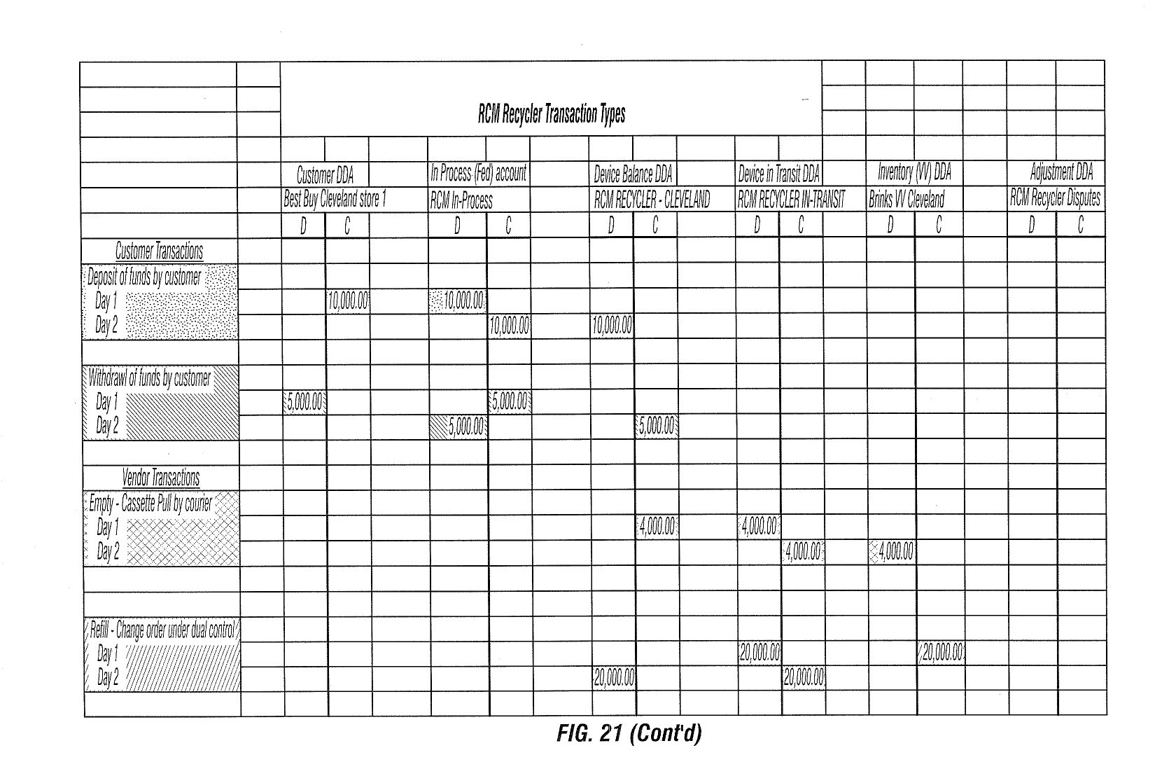

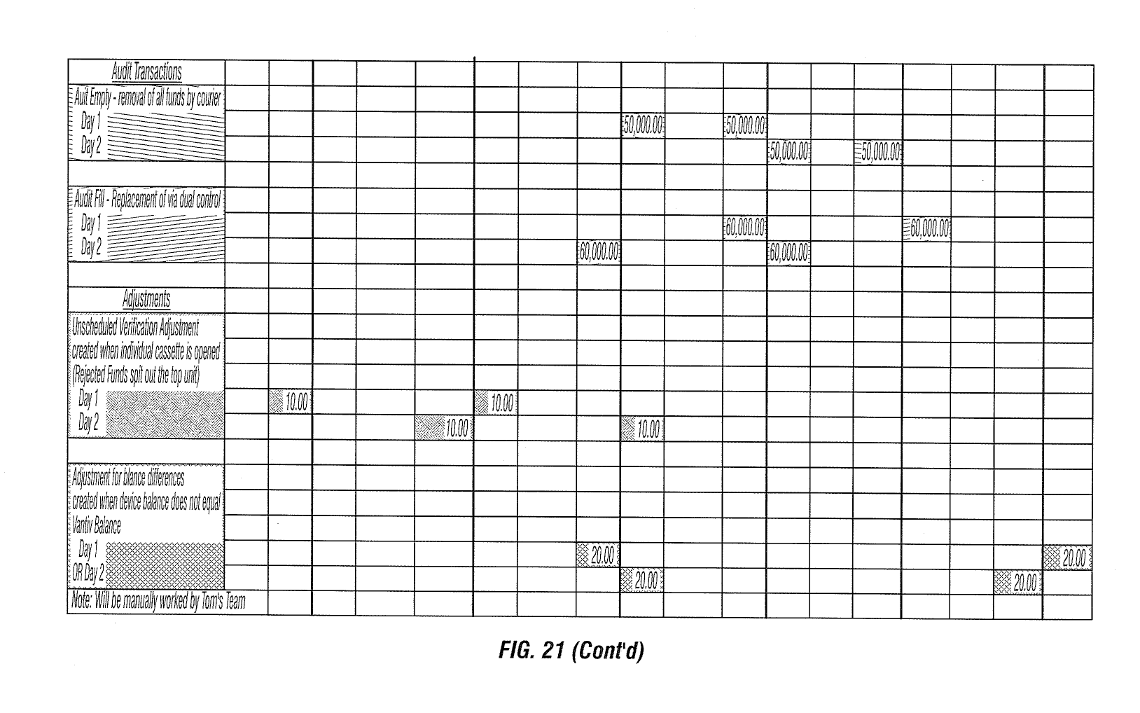

FIG. 21 depicts a diagram illustrating transaction types for the currency recycler 104, according to one or more embodiments shown and described herein. As illustrated, the currency recycler 104 transaction types include a customer DDA (retail store), an in-process (Fed) account, a device balance DDA (retail store), a device in transit, and an inventory DDA. These fields may receive both customer transactions and vendor transactions.

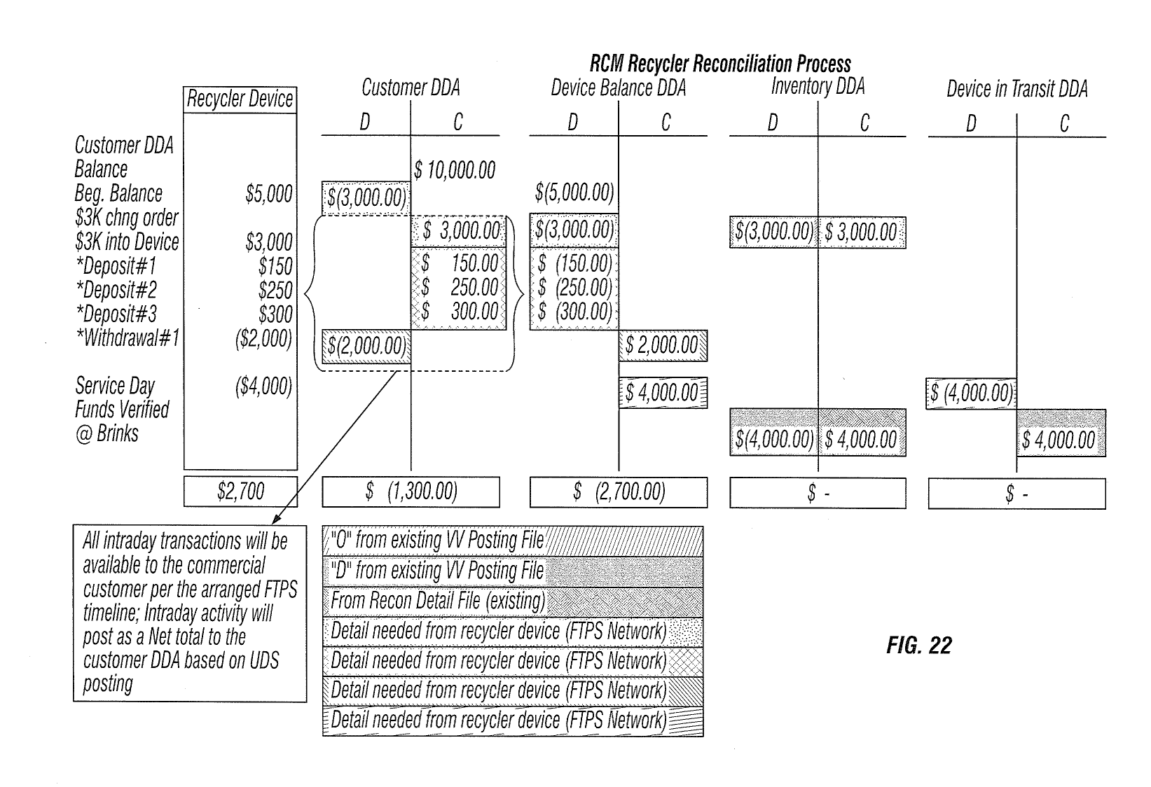

FIG. 22 depicts a diagram illustrating a reconciliation process for the currency recycler 104, according to one or more embodiments shown and described herein. As illustrated, FIG. 22 depicts balances for a currency recycler 104 for customer DDA, device balance DDA, inventory DDA, and device in transit DDA.

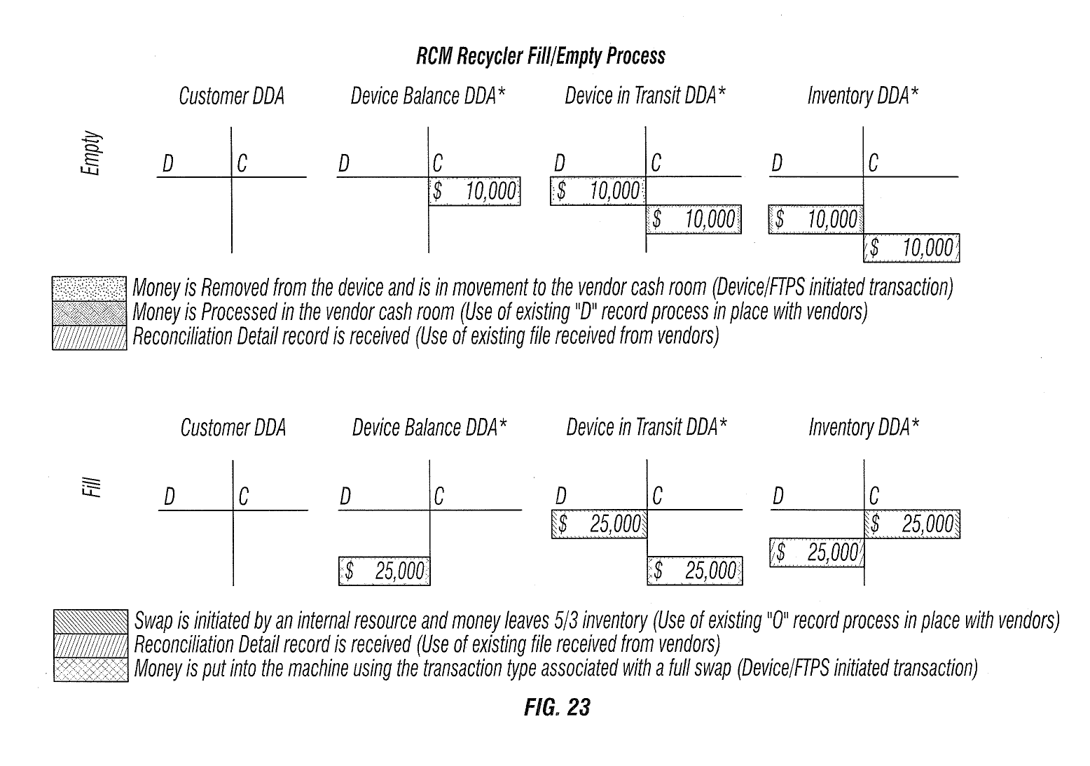

FIG. 23 depicts a diagram illustrating a fill/empty process for the currency recycler 104, according to one or more embodiments shown and described herein. As illustrated, the currency recycler 104 fill/empty process may include an indication of when currency is removed from the currency recycler 104, when money is processed in the vendor currency room, and when a reconciliation detail record is received.

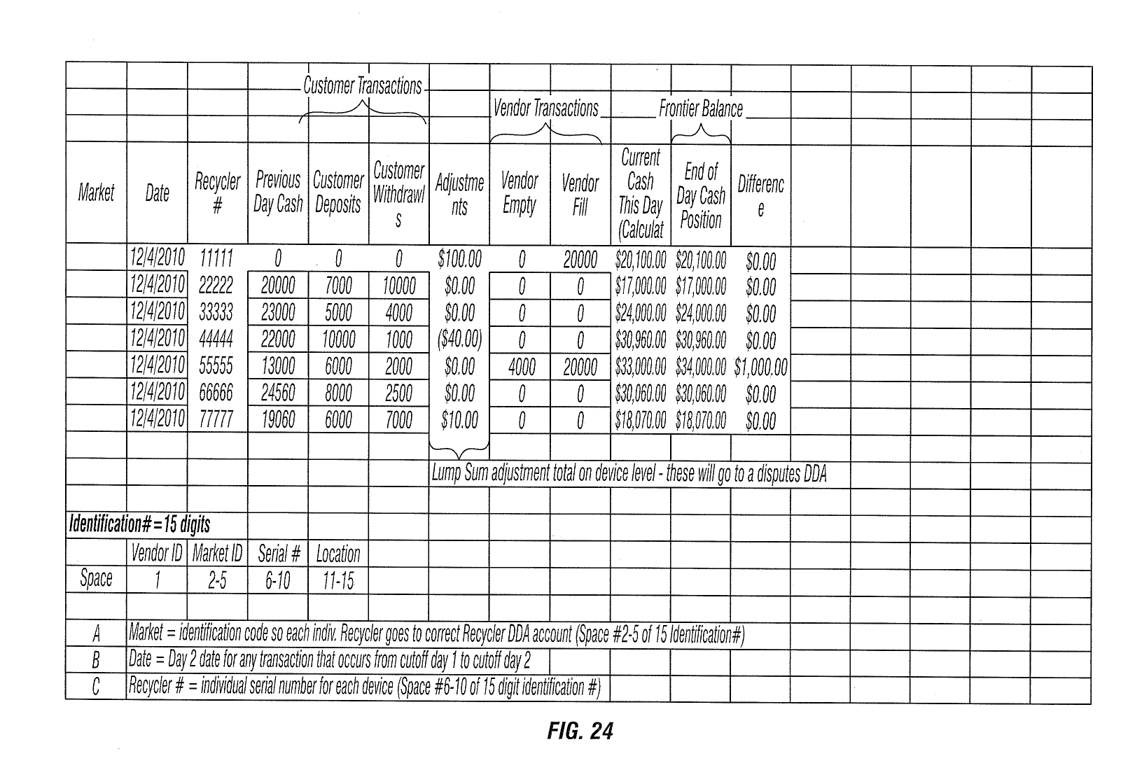

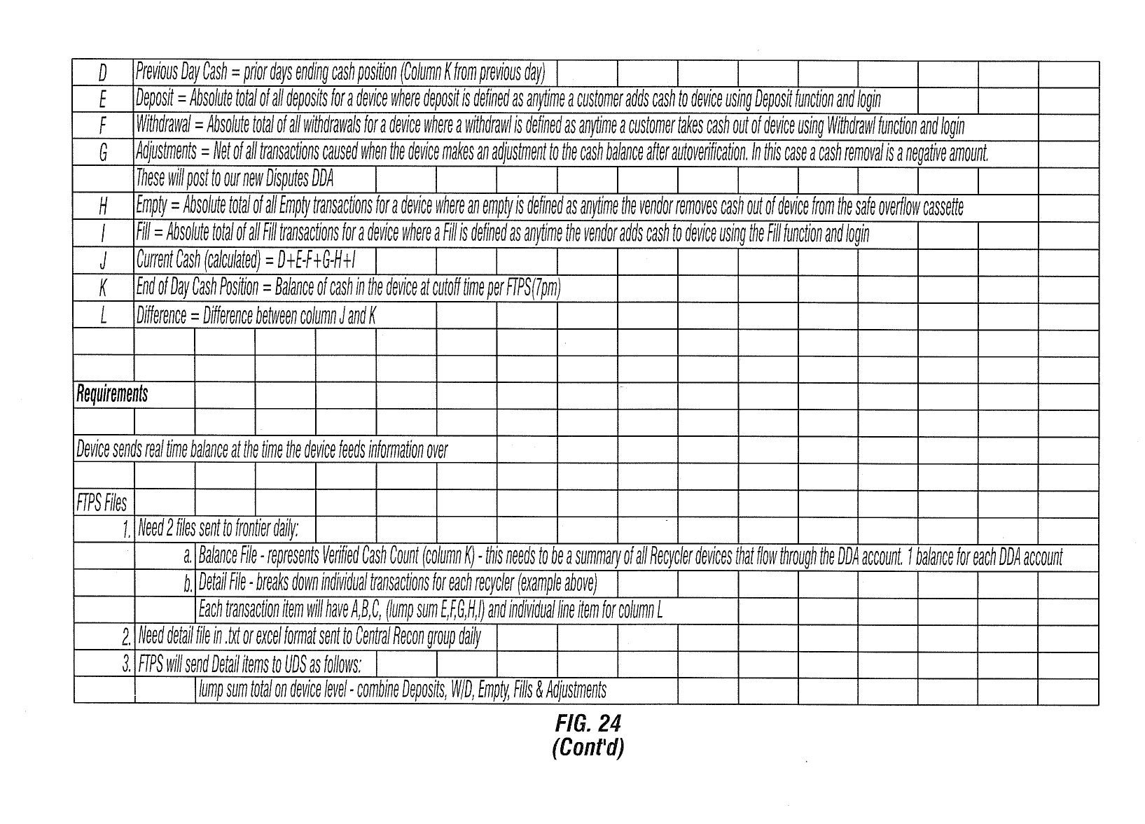

FIG. 24 depicts a diagram illustrating customer transactions with the currency recycler 104, according to one or more embodiments shown and described herein. As illustrated, included are a market field, date field, a currency recycler field, a previous day cash field, a customer deposits field, a customer withdrawals field, an adjustments field, a vendor empty field, a vendor fill field, a current cash field, an end of day cash position field, and a difference field.

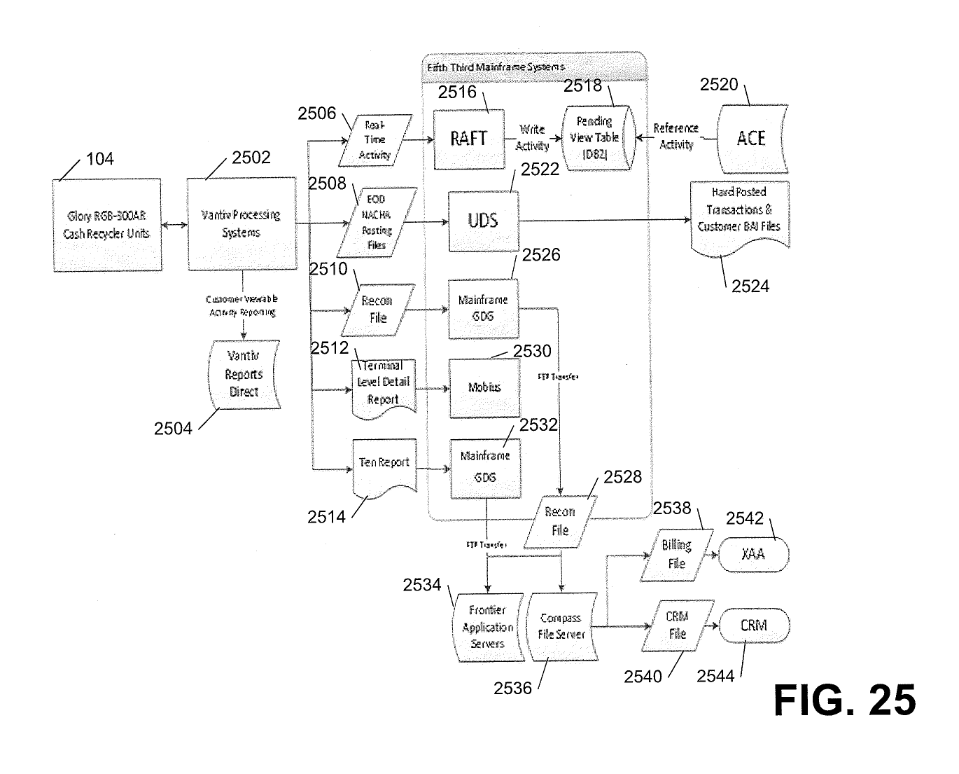

FIG. 25 depicts a flowchart illustrating operation of the currency recycler 104 in conjunction with an example remote computing device 102, according to one or more embodiments shown and described herein. As illustrated a currency recycler 104 may communicate with a processing system 2502. The processing system 2502 may send customer viewable reports to a reports direct component 2504. Additionally, in the embodiment shown, the processing system 2502 may report real time activity 2506 to a reliable automated funds transfer (“RAFT”) component 2516, which stores customer relationship information and writes customer pending activities to a table 2518. In this example, the table 2518 may also receive reference activity, such as from queries, from an a front end user interface 2520 (labeled “ACE” in this example).

The processing system 2502 may additionally send posting files to a universal deposit system (“UDS”) component 2522, which stores customer checking and saving account information that could include creation of hard posted transactions and customer files 2524. In the embodiment shown, the processing system 2502 may also send files 2510 to a mainframe 2526, which in this embodiment, file transfer protocol (“FTP”) transfers the file to a cash vault management application 2536 for customer profiles and billing (labeled “compass file server”). The processing system 2502 may also send a terminal level detail report to a reporting engine 2530 (labeled “mobius”). The processing system 2502 may additionally send a ten report 2514 to a mainframe 2532, which in this example, FTP transfers the data to a reconciliation program (labeled “frontier application servers”) and to the cash vault management application (labeled “compass file server”) 2536. The cash vault management application 2536 may send a billing file 2538 to an extended account analysis application (labeled “xaa”) 2542 and a customer relationship management (“CRM”) file 2540 to a CRM application 2544.

FIG. 26 depicts a flowchart illustrating operation of depository versus non-depository transactions, according to one or more embodiments shown and described herein. As illustrated, cash electronification actions may include the currency recycler 104 transactions sent to the financial institution via a third party. A determination may then be made regarding whether the transaction is a financial institution depository DDA or non-depository. If the transaction is depository, the currency recycler 104 transactions may settle directly to the financial institution DDA account. If the transaction is non-depository. Intraday transactions on the currency recycler 104 may hit a financial institution internal in-process account. The daily settlement with the customer's financial institution may then occur.

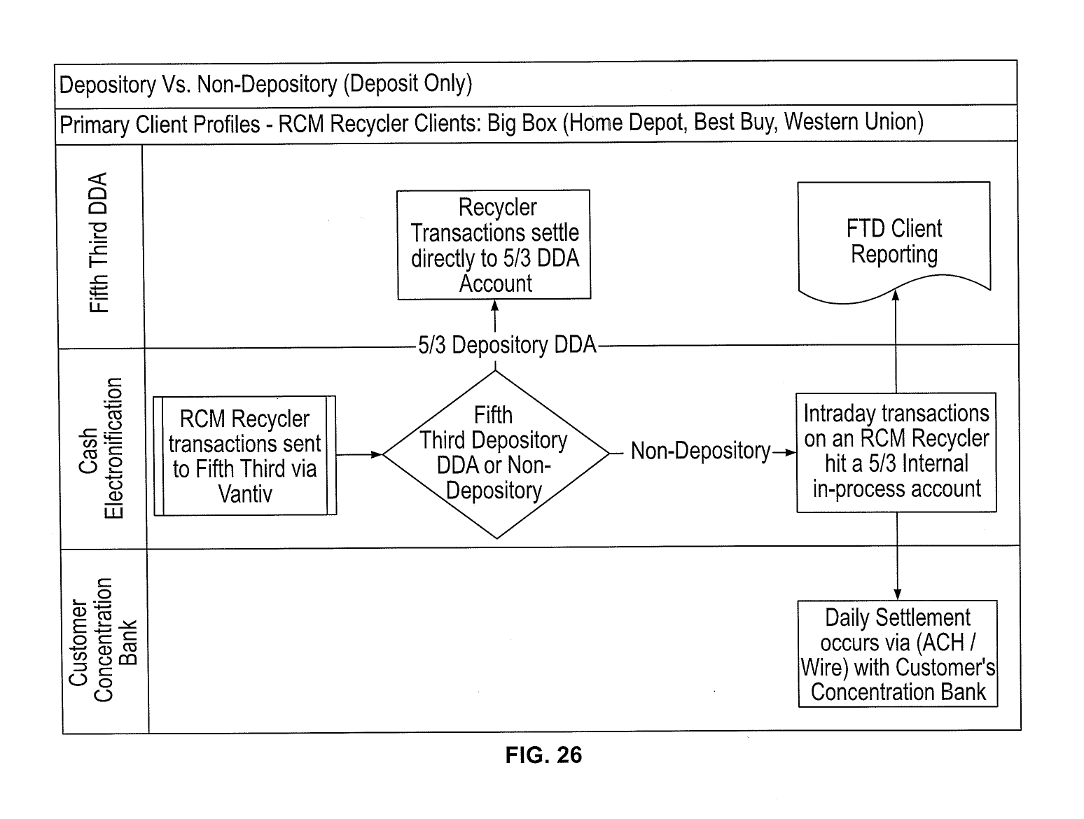

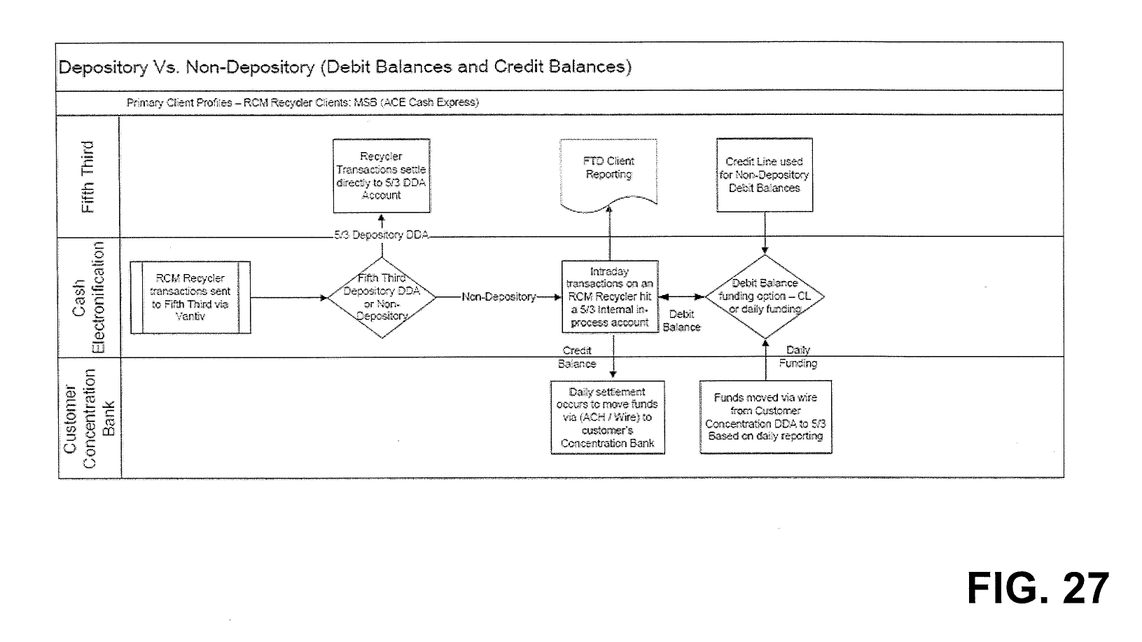

FIG. 27 depicts a flowchart illustrating depository versus non-depository debit and credit balances, according to one or more embodiments shown and described herein. As illustrated, the currency recycler 104 transactions may be sent to the financial institution via a third party. A determination may then be made regarding whether the transaction is depository or non-depository. If the transaction is depository, the currency recycler 104 transactions may settle directly to the financial institution DDA account. If the transaction is non-depository, the intraday transactions on the currency recycler 104 may hit an internal in-process account of the financial institution and a daily settlement may occur to move funds to the customer's financial institution. Additionally, a determination may be made regarding whether the transaction includes a debit balance funding option or a daily funding. A credit line may be used for non-depository debit balances and funds via a wire from the customer to the financial institution may be moved, based on daily reporting.

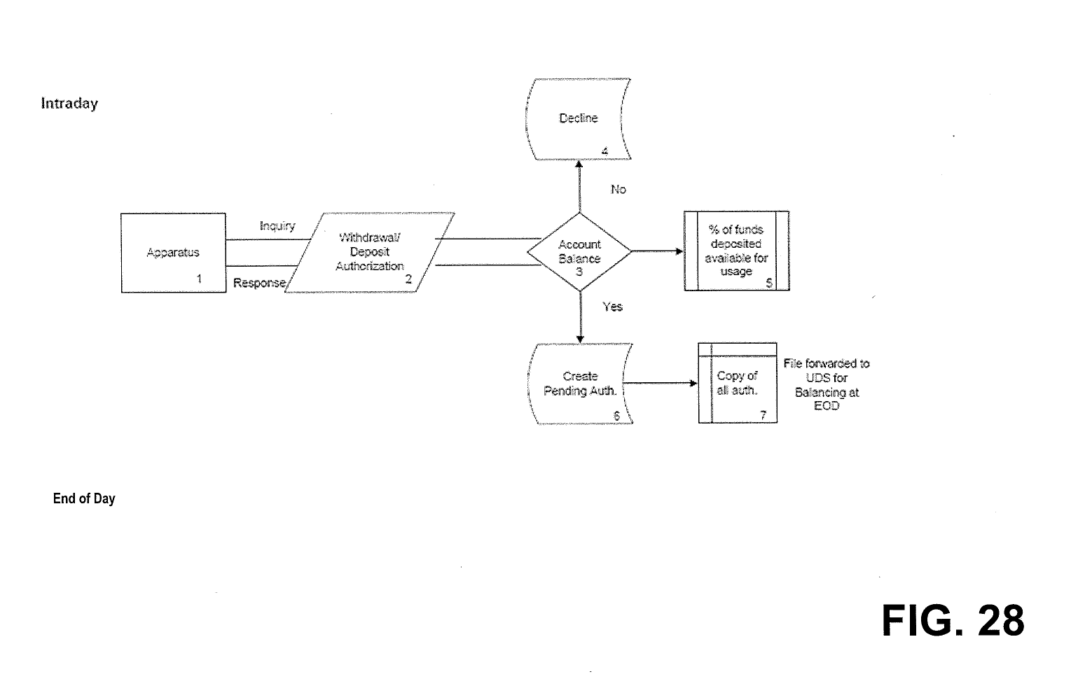

FIG. 28 depicts a flowchart illustrating intraday operation of the currency recycler 104, according to one or more embodiments shown and described herein. As illustrated, at the apparatus block the currency recycler 104 receives a retailer request for deposits and/or withdrawals at the currency recycler 104, which creates messaging for these inquiries. The messages may be sent to the financial institution. Additionally, the currency recycler 104 can receive a response back from the financial institution. At the withdrawal/deposit authorization block, authorization data (such as a PIN) is received from the retailer at the currency recycler 104, which is communicated through ATM networks to provide authorization. At the account balance block, a determination is made regarding whether there are sufficient funds in the retailer's account to complete the transaction. If not, at the decline block, the transaction may be declined. If funds are available, but preset parameters limit the transaction, the process proceeds to the percentage of funds block, where a percentage of the funds may be available to the retailer. If, at the account balance block, a determination is made that the funds are fully available, the process may proceed to the create pending authorization block, where the transaction may be processed and a pending message is created and stored for end of the day processing. At the copy of authorization block, a copy of the preliminary authorization is stored and all such authorizations are forwarded to the financial institution for settlement processing. Upon processing by the financial institution, the transaction is complete.

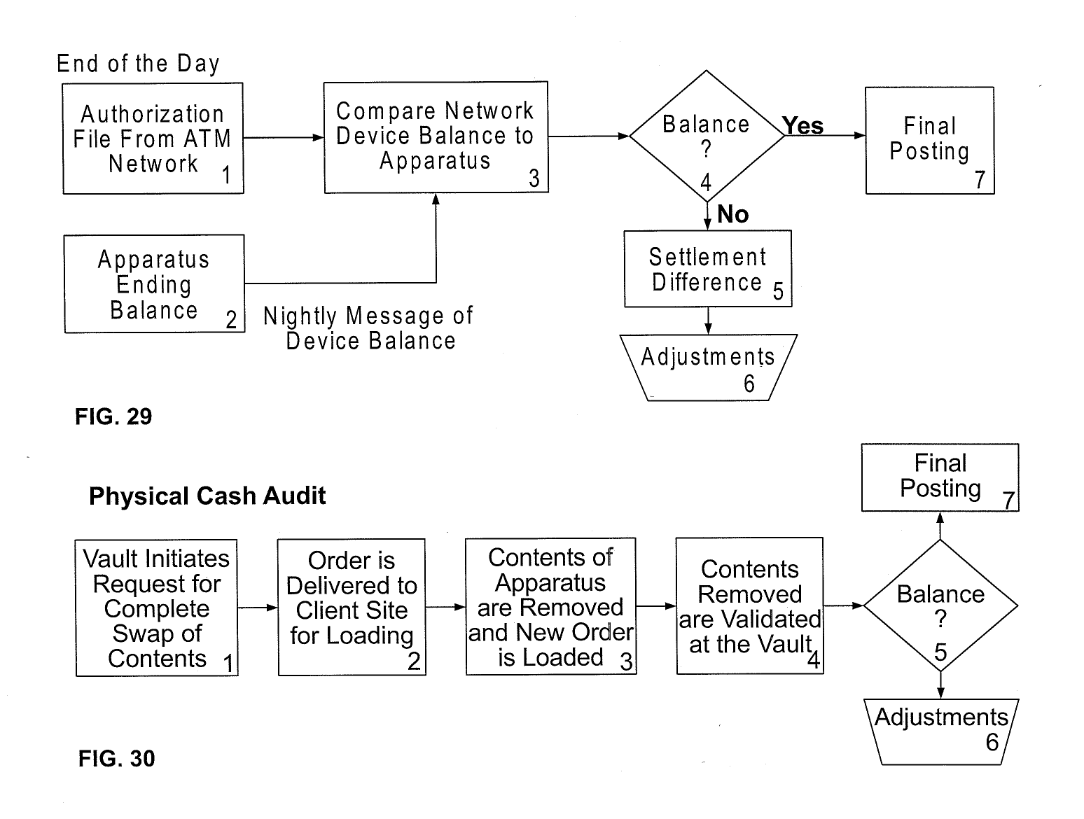

FIG. 29 depicts a flowchart illustrating end of day transactions of the currency recycler 104, according to one or more embodiments shown and described herein. More specifically, pending authorizations may be received from an ATM network provider. An ending day balance may be received from the currency recycler 104. A comparison of the files from the device and ATM network may be performed to reconcile the account balances between the client and the device. Decision point may be performed for determining balanced records. If not balanced, differences in the settlement process are identified in the frontier system. Accounting researches and resolves difference through adjustment process. If there is balance, a final posting may be performed for the accounts.

The banking day is a twenty-four (24) hour period that extends from midnight to midnight. Oftentimes, because of shift changes or the hours of a business, businesses generally do not close out cash registers associated with point-of-sale systems at the end of a banking day. Customers of the currency recyclers disclosed herein are able to change the end of day to their desired end of day. In an illustrative example, an “always open” gas station or convenient store may close their registers at the slowest time of the day, for example, 3 a.m. In such an embodiment, the customer may change their end of day to 3 a.m. At 3 a.m. each day, the customer would then close out the cash registers associated with their point-of-sale system. The bank would recognize the customer end of day as being 3 a.m. and would reconcile deposits and withdrawals at the currency recycler 104 according to a user-selected end of day. In illustrative embodiments, the customer end of day may be set to any time other than midnight and may be customized for each customer. In some embodiments, the end of day may be changed, for example, by the customer, but may be pre-set and may not be changed unless the system is overridden. In other embodiments, the end of day may be changed “on the fly”, for example, by the customer. In a non-limiting example, the customer may change the end of day on Saturdays and/or Sundays or the customer may change the end of day for holidays, slow days, or any anomaly that may appear during the week. In another non-limiting example, the customer may have the ability to change the end of day based on a more convenient time for the customer, which may change from day to day (and may be different every day). For example, the customer may wish to perform end of day operations at a time when the customer's store is slow, the appropriate personnel have downtime, or a time that is more convenient for personnel, in which case, the customer may select a different end of day every day.

FIG. 30 depicts a flowchart illustrating a physical cash audit of the currency recycler 104, according to one or more embodiments shown and described herein. As illustrated, accounting initiates a complete cash swap (change order) of the device. An armored car vendor may deliver the change order to client's location. Contents of the machine may be removed from the currency recycler 104 and the change order may be deposited into the currency recycler 104. Armored car courier delivers contents that were removed from the currency recycler 104 to the vault location for verification. A determination may be made regarding whether the contents are balanced to accounting records. If not, differences will be handled as adjustments by either adjusting internal entries or the customer account. Verification is complete once records have been balanced. If so, final posting may be performed.

FIG. 31 depicts a flowchart illustrating an exchange transaction of the currency recycler 104, according to one or more embodiments shown and described herein. In this embodiment, the user has selected to initiate an exchange transaction (block 3100), for example by selecting an exchange transaction through the input hardware 232 on the currency recycler 104. An exchange transaction is generally one in which the user would like to obtain certain denominations of currency in exchange for a different denomination. Consider an example in which the user has a $20 bill and would like to exchange this for twenty $1 bills. In existing systems, the user would start with a deposit of the $20 bill and then attempt to receive a withdrawal of twenty $1 bills. However, one shortcoming of this approach arises when the denomination desired by the user is unavailable. For example, if only eighteen $1 bills are available, existing systems would receive the $20 bill deposit, then dispense eighteen $1 bills and credit the account by $2, which is not what was desired by the user. In this embodiment, the exchange transaction of the currency recycler 104 starts with the withdrawal of the desired denomination(s) before depositing any money (block 3102). This allows the user to first select the desired denomination(s), such as twenty $1 bills, using the input hardware 232 (block 3104). The recycler is configured to determine whether the desired denomination(s) are available (block 3106), such as using the data storage element 236 (block 3108). If the desired denomination(s) are available, this is dispensed to the user (block 3110) before starting the withdrawal transaction (block 3114). If the above example, the user would be alerted to the fact that the recycler does not have twenty $1 bills and ask whether the user would like to select different denomination(s) (block 3112). This provides the user with an opportunity select, for example, one $5 bill and fifteen $1 bills. Once the desired denomination(s) are selected and determined to be available, this is dispensed to the user (block 3110). At that time, the user deposits the money in exchange, which would be the $20 bill in this example (block 3114).

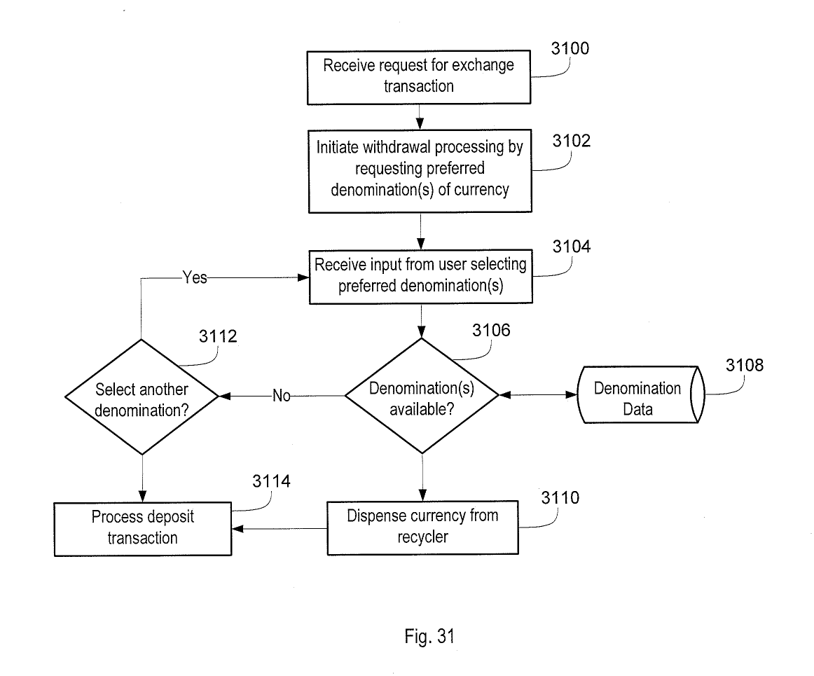

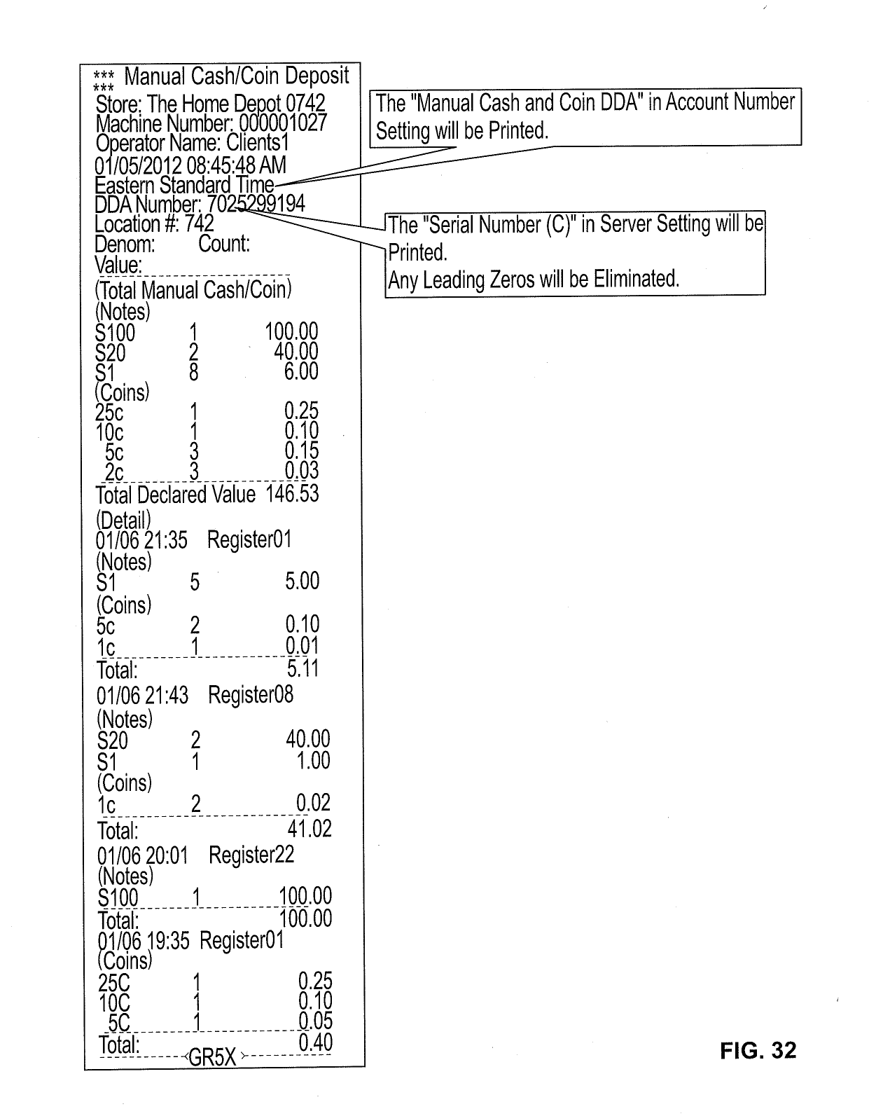

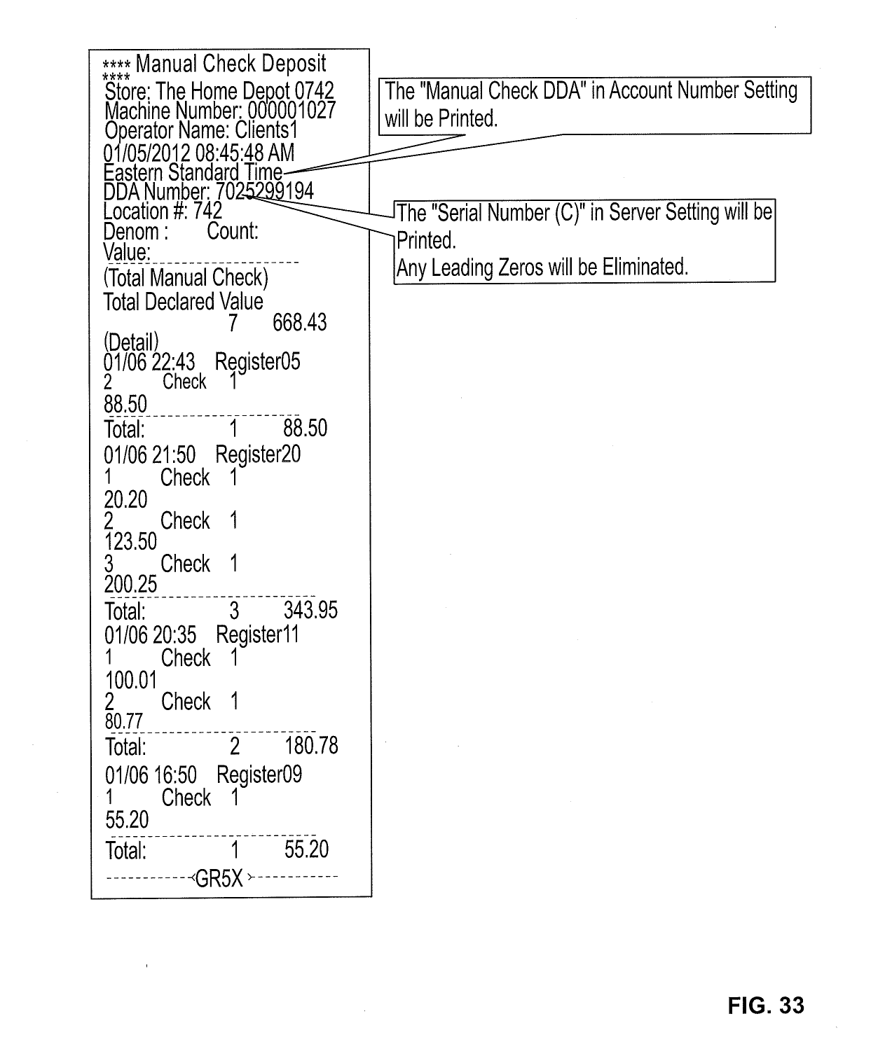

FIGS. 32 and 33 show example receipts that could be issued from the currency recycler 104 in conjunction with manual processing of coinage and checks, respectively. In this embodiment, a user may select a manual processing transaction from the currency recycler 104. This allows the user to deposit coinage and/or checks and receive provisional credit for these items. In this embodiment, the currency recycler 104 is configured to provide a net credit for all validated and manually deposited cash and coins and a second net credit for all manually deposited checks that will be posted to the user's account. Consider an example in FIG. 32 in which the user has performed a manual deposit of one $100 bill, two $20 bills, six $1 bills, one quarter, one dime, three nickels, and three pennies for a total manual deposit of $146.53, for which the user will be provided provisional credit. As shown in this example receipt, the user may enter the cash register from which this money came, which could be reconciled with the customer's point of sale system. Likewise, in the example receipt illustrated in FIG. 33, the user is allowed to deposit multiple checks for a total declared value of $558.43. In this example, the customer's account will be provided a provisional credit for $558.43, which is the amount declared for these checks.

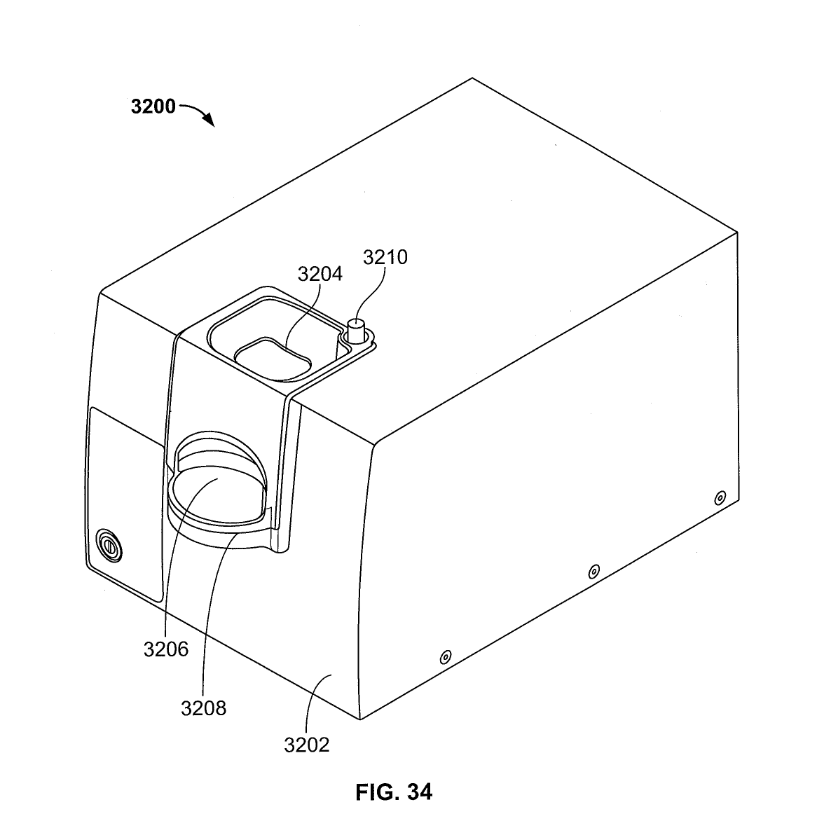

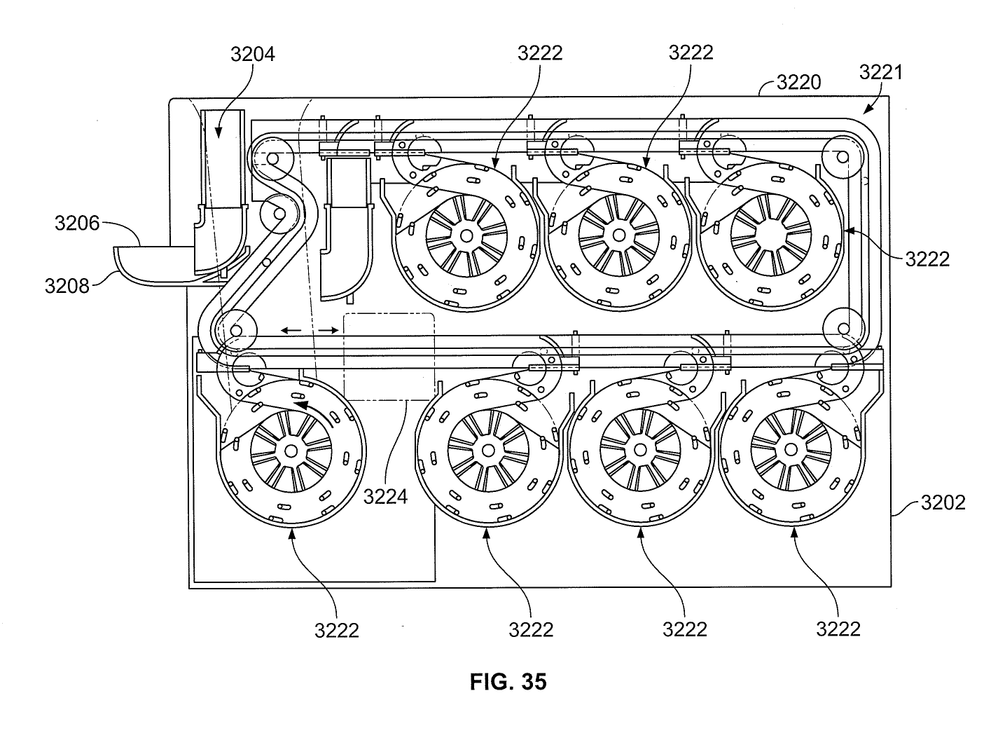

FIGS. 34 and 35 depict an illustrative embodiment of a coin recycling unit 3200 that may be used as a standalone unite or may be integrated with any of the currency recyclers disclosed herein, as will be discussed in greater detail herein. As best seen in FIG. 34, the coin recycling unit 3200 may generally include a housing 3202 including a coin receiving port 3204 for inserting coins into the unit 3200 and a coin dispensing port 3206 including a coin dispensing tray 3208 for holding coins dispensed from the unit 3200 through the coin dispensing port 3206. The coin recycling unit 3200 may further include a button or other actuator 3210 for releasing coins placed within the coin receiving portion 3204 into the coin recycling unit 3200.

Referring to FIG. 35, the coin recycling unit 3200 includes a coin transporting unit 3221 disposed within the housing 3202 for transporting coins placed into the coin receiving portion 3204 into dispensing units 3222. In an illustrative embodiment, each of the dispensing units 3222 may hold and dispense a particular denomination of coin. In other illustrative embodiments, more than one dispensing unit 3222 may hold and dispense a particular denomination. In an illustrative example, wherein a retail establishment receives and dispenses a lot of quarters, the coin recycling unit 3200 may hold five dispensing units 3222, one for pennies, one for nickels, one for dimes, and two for quarters. Any number of dispensing units 3222 may be utilized for varying combinations of coins, but each dispensing unit 3222 holds and dispenses a single denomination of coin. A recognition unit 3224 for properly recognizing denominations of coins may be disposed in communication with the transporting unit 3220. An illustrative coin recycling unit 3200 is disclosed in U.S. Pat. No. 8,216,032, the disclosure of which is hereby incorporated in its entirety herein. In other illustrative embodiments, the principles of the present application may be implemented within any suitable coin recycling unit 3200.

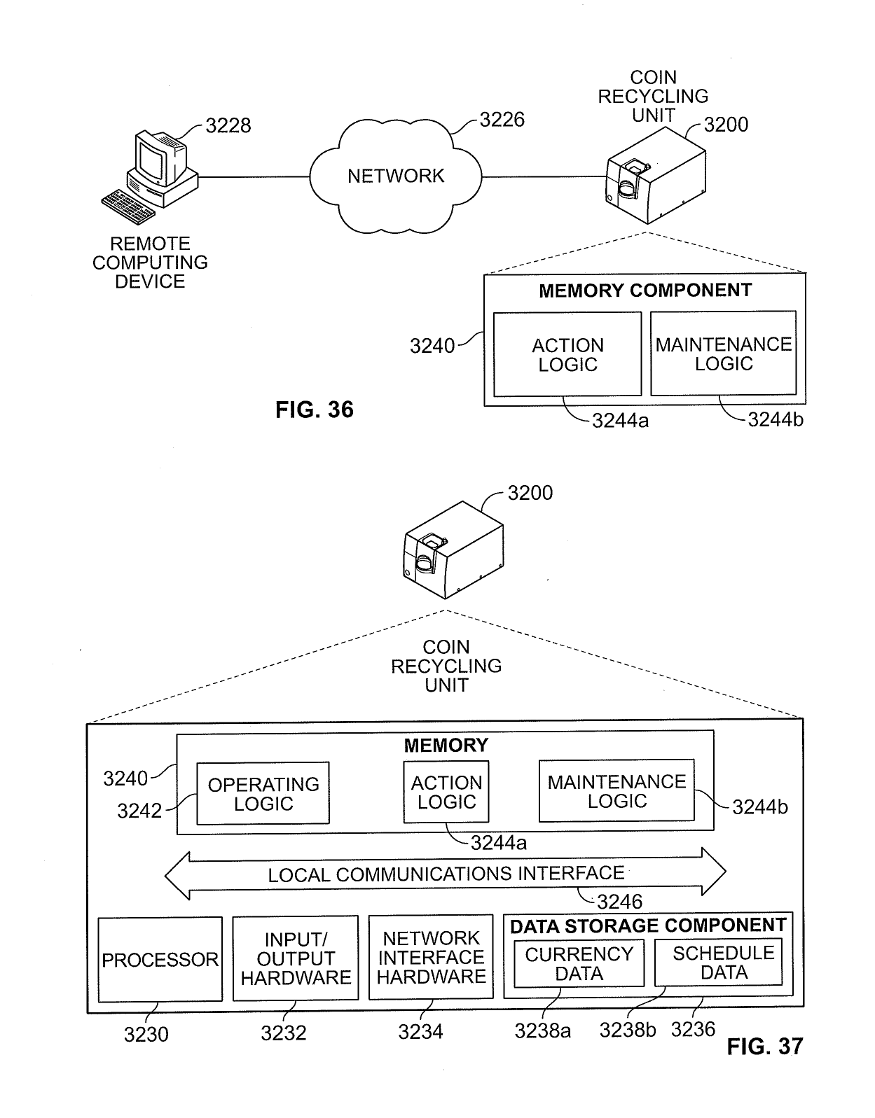

Similar to the currency recycler 104, and referring to FIGS. 36 and 37, a remote computing device 3228 and the coin recycling unit 3200 may be communicably coupled to a network 3226. The network 3226 may include a wide area network and/or a local area network and thus may be wired and/or wireless. The remote computing device 3228 may include any portable and/or non-portable computing device, such as personal computer, laptop computer, tablet computer, personal digital assistant (PDA), mobile phone, etc. The remote computing device 3228 may additionally include other communication infrastructure, such as infrared, Wi-Fi™, near field communication to function as a remote control of one or more coin recycling units 3200.

The coin recycling unit 3200 includes a processor 3230, input/output hardware 3232, network interface hardware 3234, a data storage component 3236 (which stores currency data 3238a, schedule data 3238b, and/or other data), and the memory component 3240. The memory component 3240 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, the non-transitory computer-readable medium may reside within the coin recycling unit 3200 and/or external to the coin recycling unit 3200.

Additionally, the memory component 3240 may store operating logic 3242, action logic 3244a, and maintenance logic 3244b. The action logic 3244a and the maintenance logic 3244b may each include a plurality of different pieces of software algorithms, each of which may be embodied as a computer program, firmware, and/or hardware, as an example. A local communication interface 3246 may also be included and may be implemented as a bus or other communication interface to facilitate communication among the components of the coin recycling unit 3200.

The processor 3230 may include any processing component operable to receive and execute instructions (such as from the data storage component 3236 and/or the memory component 3240). The input/output hardware 3232 may include and/or be configured to interface with a monitor, positioning system, keyboard, display, touch screen, mouse, printer, image capture device, microphone, speaker, gyroscope, compass, and/or other device for receiving, sending, and/or presenting data. The network interface hardware 3234 may include and/or be configured for communicating with any wired or wireless networking hardware, including an antenna, a modem, LAN port, wireless fidelity (Wi-Fi) card, Bluetooth™ hardware, WiMax card, mobile communications hardware, and/or other hardware for communicating with other networks and/or devices. From this connection, communication may be facilitated between the coin recycling unit 3200 and the currency recycler 104.

Once coins are released into the transporting unit 3220, the coins are counted and moved to the appropriate dispensing unit 3222. In a manner similar to that described above with respect to the deposit of notes, the processor 3230 may cause a total of the dollar amount of the coins counted to be sent via the network 3226 to the bank to be credited to the customer's account. In a similar manner, the customer may request, through the input/output hardware 3232, for example, a display or a touch screen, withdrawal of particular denominations and numbers of coins and the coins will be dispensed. In other illustrative embodiments, the display or touch screen may display any number of different combinations of coins for selection and dispensing. In an illustrative example, a first selection may be a “start of day” coin selection in which the coins necessary for a shift are dispensed (e.g., 20 quarters, 20 dimes, 20 nickels, and 20 pennies), a second selection may be a “low quarter” coin selection in which only quarters (e.g., 20 quarters) are dispensed, and a third selection may be a “reload” coin selection in which a reload of all coins is dispensed (e.g., 5 quarters, 5 dimes, 5 nickels, and 5 pennies). As one skilled in the art will understand, numerous different selections (types of denominations and number of each denomination) may be created and implemented. Any number of selections may be presented to a user and the user may select any number of the selections to dispense the desired coins. The same process may be applied to notes, wherein the user may choose from a number of different combinations of notes for dispensing.

While the currency recycler 104 and the coin recycling unit 3200 are described and depicted as being separate units and having separate computing components, the currency recycler 104 and the coin recycling unit 3200 may be a single, integrated unit and/or the currency recycler 104 and the coin recycling unit 3200 may share a single set of computing components. Regardless, the currency recycler 104 and the coin recycling unit 3200 may operate as an integral unit. In an illustrative embodiment, a user may perform a withdrawal or a deposit transaction via a single display and may be allowed to withdraw or deposit both notes and coins from the currency recycler 104 and/or the coin recycling unit 3200, respectively, in a single operation.

The coin recycling unit 3200 may include a coin counting function in which a user selects a deposit transaction via a display or touchscreen (which may be part of the input/output hardware 3232 of FIG. 37) and deposits a number of coins into the coin receiving port 3204 and presses the actuator 3210 to release the coins into the coin transporting unit 3220. After counting the coins, the display associated with the coin recycling unit 320 may display the coin denominations, the number of each type of coin that was deposited, and a total for the deposit transaction. The user may thereafter select, via the display, to initiate a withdrawal transaction in which the user may select the same denominations and number of coins of each denomination for dispensing. In an illustrative embodiment, the display may include an icon for selecting the last-deposited denominations and number of coins of each denomination for dispensing. Regardless, the same denominations and number of coins of each denomination are dispensed, although the same exact coins that were deposited are likely not dispensed.

The coin recycling unit 3200 may also include a coin exchange function in which a user selects a deposit transaction via a display (associated with the coin recycling unit 3200, the currency recycler 104, or both) and deposits a number of coins into the coin receiving port 3204 and may press the actuator 3210 to release the coins into the coin transporting unit 3220. After counting the coins, the display associated with the coin recycling unit 3200 displays the coin denominations, the number of each denomination of coin that was deposited, and a total for the deposit transaction. The user may thereafter select, via the display, to initiate a withdrawal transaction in which the user selects denominations for dispensing (presumably with the same total as the deposit transaction). In an illustrative embodiment, the user may deposit 1000 pennies and may request dispensing of 40 quarters. In illustrative embodiments wherein the currency recycler 104 and the coin recycling unit 3200 are integrated into a single system, the user may be able to select any combination of notes and/or coins for dispensing in response to depositing of any number of different notes and/or coins.

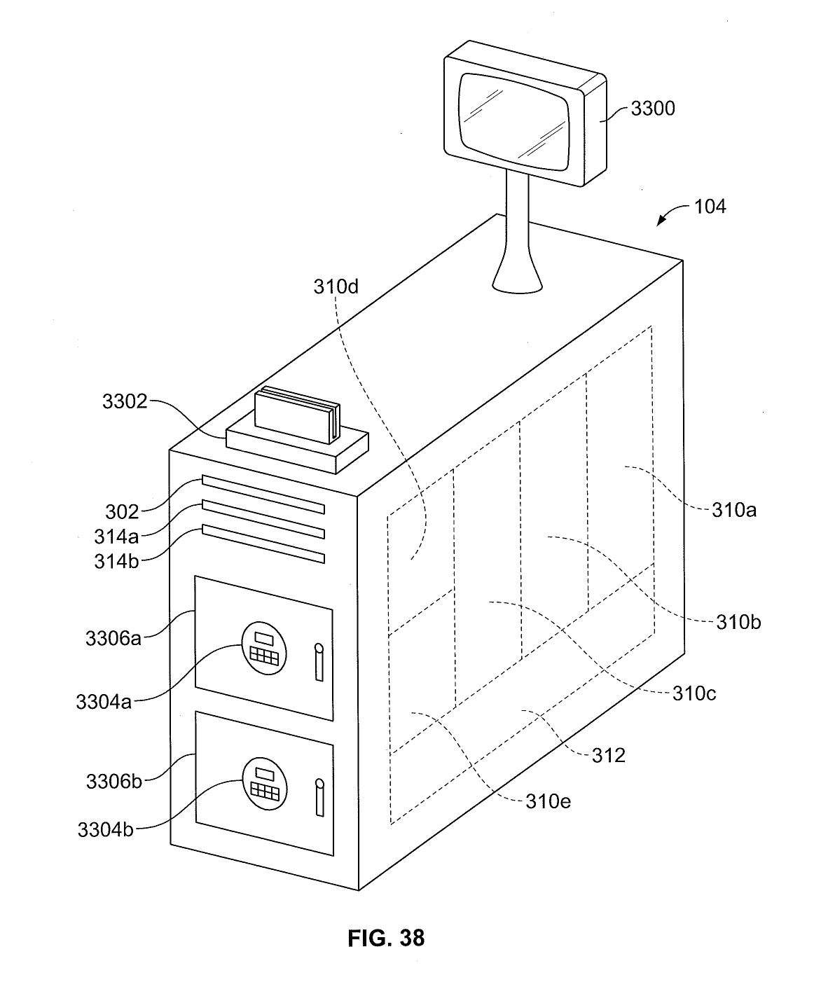

In illustrative embodiments, the currency recycler 104 input/output hardware 232 (of FIG. 2) includes a display or touchscreen 3300, as seen in the currency recycler 104 of FIG. 38, that is configured to allow access to only registered users of the currency recycler 104. More particularly, a login screen may be presented on the display, wherein a user may be required to login in order to complete transactions at the currency recycler 104. The login process may require a login and password. In illustrative embodiments, the login process may additionally or alternatively require enhanced security, such as, for example, a magnetic stripe card reader 3302 in communication with the processor 230 of the currency recycler 104. In such embodiments, a user may be provided with magnetic stripe cards storing data related to the user. When the magnetic stripe card is swiped through the magnetic stripe card reader 3302, the data from the magnetic stripe card is read by a magnetic reading head of the reader, the data is sent to the processor 230, and the processor 230 verifies that the user of the magnetic stripe card has appropriate access to the currency recycler 104 and/or that the data from the magnetic stripe card matches the username and login being utilized to login to the currency recycler 104. The reader 3302 may be integrated within the currency recycler 104, may be attached to the currency recycler 104, or may be freestanding and connected to the recycler 104 either wirelessly or by a cord. If integrated or attached to the currency recycler 104, the reader 3302 may be positioned in any suitable location on the currency recycler 104. Other enhanced security features may additionally or alternatively be used. An example of a further enhanced security feature includes, but is not limited to, one-way hash technology that ensures the right user is accessing the currency recycler 104. The coin recycling unit 3200, as described herein, may be integrated with the currency recycler 104 such that a single login process provides a user access to both the currency recycler 104 and the coin recycling unit 3200. In other embodiments, the currency recycler 104 and the coin recycling unit 3200 may operate independently of one another, in which case, the coin recycling unit 3200 may include any of the disclosed security access features.

Exemplary users of the currency recycler 104 and/or coin recycling unit 3200 may be cashiers, in which case, the cashiers login to the currency recycler 104 and/or coin recycling unit 3200 to withdraw currency, for example, at the beginning of a shift and deposit currency, for example, at the end of a shift. The withdrawn currency may then be placed within, for example, a cashier register to which the cashier is assigned. Cashiers (or other users) may also make withdrawals when currency within their register is running low or make deposits when there is too much currency within their register, their register includes large bills, or it is the end of a day or shift. Regardless of the transaction, a cashier logs in to the currency recycler 104 and/or the coin recycling unit 3200 and is associated with or assigned to a single register. In this manner, the cashier can only make deposits and withdrawals in association with their assigned register. In illustrative embodiments, a cash register may additionally or alternatively only be associated with a single user or cashier during a particular period of time (e.g., day or shift).

An electromechanical lock 3304, for example, a Kaba® Mas or any other suitable electromechanical lock, may be operatively connected to the currency recycler 104. The electromechanical lock 3304 may include any number of lock features, for example, a keypad, a display, a touch screen, or any other suitable feature(s). In illustrative embodiments, the electromechanical lock 3304 includes at least a keypad for input of an access code. In illustrative embodiments, the currency recycler 104 may include an electromechanical lock 3304a for accessing a first access door 3306a to the stackers 310a-310e and/or an electromechanical lock 3304b for accessing a second access door 3306b to the overflow cassette 312. Optionally, the currency recycler 104 may include any number of first access doors 3306a, wherein door each may access one or more of the stackers 310a-310e and each door may also have its own electromechanical lock. The access doors 3306a, 3306b may be opened upon entering of a correct authorization code at the respective electromechanical lock 3304a, 3304b. The access codes for each of the electromechanical locks 3304a, 3304b may be the same or different. While two electromechanical locks are depicted, a single electromechanical lock may be utilized for either or both of the stackers 310a-310e, the overflow cassette 312, or any other access point.

In illustrative embodiments, a courier that withdraws and restocks the currency recycler 104 with currency may have an authorized login and password for removing currency within the overflow cassette 312, in which case, the courier would be provided a login and password for logging into the currency recycler 104. In other illustrative embodiments, it may be necessary for a customer to fix something within the overflow cassette 312 or one of the stackers 310a-310e, thus necessitating access to the overflow cassette 312 or the stackers 310a-310e. It may sometimes be desirous to only allow single-time access to the customer, the courier, or other users accessing internal portions of the currency recycler 104. Once the user enters the correct login and password, for example, at the display 3300 of the currency recycler 104, a one-time access code may be provided to the user. The access code may have a limited time period of use, for example, if the access code is not entered within a pre-determined time period (e.g., 60 seconds), the access code will no longer provide access to the appropriate portion of the currency recycler 104 and the user must request a new access code. If the access code is entered within the pre-determined time period, the respective door 3306a, 3306b may be opened and the contents may be accessed. Once the respective door 3306a, 3306b is closed, the respective electromechanical lock 3304a, 3304 is locked and the previously provided access code will no longer work and a new access code would have to be generated by logging on with the same or a new login and password at the display 3300. In this manner, a user may be provided one-time limited access to perform specific tasks. Optionally, a one-time access code may be generated via a mobile device application (not shown), a remote system (and relayed to the user by telephone or text message, for example), or by any other suitable method.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A non-transitory, computer readable storage medium storing a program for processing financial transactions of a retailer having a currency recycler having a housing, a processor located within the housing, and a currency routing assembly disposed within the housing to move currency to at least one stacker, according to a process comprising the steps of:
processing deposits at the at the currency recycler by accepting currency in an input port of the currency recycler and moving the currency to at least one stacker by way of the currency routing assembly;
crediting an account of a user for each deposit;
processing withdrawals at the currency recycler by moving currency from at least one stacker by way of the currency routing assembly to an output port of the currency recycler;
debiting the account of the user for each withdrawal;
reconciling all transactions at the currency recycler at an end of day; and
allowing a user to modify the end of day based on business needs.

2. The non-transitory, computer readable storage medium of claim 1, wherein the end of day selected by the user is different than a banking end of day.

3. A non-transitory, computer readable storage medium storing a program for processing financial transactions of a retailer having a currency recycler having a housing, a processor located within the housing, and a currency routing assembly disposed within the housing to move currency to at least one currency holding device, according to a process comprising the steps of:
accepting a limited-use access code at an electromechanical lock associated with an access point for at least one currency holding portion of the currency recycler;
allowing the user to open the access point for the at least one currency holding portion if the access code is authorized; and
disabling the limited-use access code after a pre-determined period of time or after the user closes the access point.

4. The non-transitory, computer readable storage medium of claim 3, further including the step of providing the user with the limited-use access code prior to accepting the limited-use access code at the electromechanical lock.

5. The non-transitory, computer readable storage medium of claim 4, wherein the limited-use access code is provided to the user via a display associated with the currency recycler.

6. The non-transitory, computer readable storage medium of claim 4, wherein the limited-use access code is provided by a remote system.

7. The non-transitory, computer readable storage medium of claim 4, wherein the limited-use access code is provided by a mobile device application.

8. The non-transitory, computer readable storage medium of claim 4, wherein the limited-use access code is provided by way of a display associated with the currency recycler.

9. The non-transitory, computer readable storage medium of claim 3, wherein the step of allowing the user to open the access point includes the step of allowing the user access to at least one stacker containing notes.

10. The non-transitory, computer readable storage medium of claim 3, wherein the step of allowing the user to open the access point includes the step of allowing the user access to an overflow cassette that holds excess notes.

11. The non-transitory, computer readable storage medium of claim 3, wherein the step of allow the user to open the access point includes the step of allowing the user to access a coin recycling unit.

12. A non-transitory, computer readable storage medium storing a program for processing financial transactions of a retailer having a currency recycler having a housing, a processor located within the housing, and a currency routing assembly disposed within the housing to move currency to at least one currency holding device, according to a process comprising the steps of:
allowing a first cashier to login to the currency recycler;
presenting to the first cashier, on a display associated with the currency recycler, a selection of a first cash register that is associated with the first cashier and which the first cashier can withdraw currency for and deposit currency from;
processing a first deposit or first withdrawal at the currency recycler by routing the currency through the currency recycler by way of the currency routing assembly, wherein the first deposit or first withdrawal is completed by the first cashier and is associated with the first cash register;
allowing a second cashier to login to the currency recycler;
presenting to the second cashier, on the display, a selection of a second cash register that is associated with the second cashier and which the second cashier can withdraw currency for and deposit currency from; and
processing a second deposit or second withdrawal at the currency recycler by routing the currency through the currency recycler by way of the currency routing assembly, wherein the second deposit or second withdrawal is completed by the second cashier and is associated with the second cash register;
wherein the first cashier cannot be associated with the second cash register and the second cashier cannot be associated with first cash register.

13. The non-transitory, computer readable storage medium of claim 12, wherein the first cash register is only associated with the first cashier during a first period of time and the second cash register is only associated with the second cashier during a second period of time.
